(19) United States
(12) Patent Application Publication
(10) Pub. No.: US 2014/0184573 A1
(43) Pub. Date: Jul. 3, 2014

(54) Electromechanical Systems Color Transflective Display Apparatus

(71) Applicant: PIXTRONIX, INC., San Diego, CA (US)

(72) Inventors: Nikolay I. Nemchuk, North Andover, MA (US); Gianni Taraschi, Arlington, MA (US)

(73) Assignee: Pixtronix, Inc., San Diego, CA (US)

(21) Appl. No.: 13/729,755

(22) Filed: Dec. 28, 2012

(51) Int. Cl. G02B 26/02; G09G 3/34; G02B 26/00

(52) U.S. Cl. CPC G02B 26/02; G02B 26/002; G09G 3/34
USPC 345/204; 359/230

(57) ABSTRACT

This disclosure provides systems, methods and apparatus for modulating light in reflective and transmissive modes of operation. In one aspect, an apparatus may include an array of electromechanical systems (EMS) light modulators. Each light modulator can be configured to achieve at least three states, including a non-transmissive, non-reflective state, a light transmissive state in which the light modulator transmits light, and a first reflective state in which the light modulator reflects a color.

### TECHNICAL FIELD

This disclosure relates to the field of displays, and in particular, to electromechanical systems (EMS) displays capable of providing color images in both reflective and transmissive modes.

### DESCRIPTION OF THE RELATED TECHNOLOGY

Transmissive displays can deliver color images with acceptable contrast ratios under indoor ambient lighting conditions. However, transmissive displays may become difficult to view, or at least have a substantially reduced contrast ratio, when viewed outdoors or in other high ambient lighting conditions. In contrast, reflective displays generally perform better in high ambient light conditions and can perform worse in low ambient lighting conditions. That is, neither class of device performs equally well in both outdoor and indoor ambient lighting conditions.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus that includes an array of electromechanical systems (EMS) light modulators. Each light modulator can be configured to achieve at least three states, including a non-transmissive, non-reflective state, a light transmissive state in which the light modulator transmits light, and a first reflective state, in which the light modulator reflects a color.

In some implementations, the light modulator is configured to transition between the non-transmissive, non-reflective state and the light transmissive state through movement in a first direction having a first axis of motion and to transition between the non-transmissive, non-reflective state and the first reflective state through movement in a second direction having a second, different axis of motion. In some such implementations, the first axis of motion is substantially perpendicular to the second axis of motion. In some other implementations, the light modulator is configured to transition between the non-transmissive, non-reflective state and the light transmissive state through movement of a first distance in a first direction and to transition between the non-transmissive, non-reflective state and the first reflective state through movement of a second, greater distance in the first direction.

In some implementations, the apparatus includes a controller configured to operate the array of light modulators in a transmissive mode and in a reflective mode. In the transmissive mode, the controller is configured to cause the light modulators in the array to be selectively driven between the non-transmissive, non-reflective state and the light transmissive state. In the reflective mode, the controller is configured to cause the light modulators in the array to be selectively driven between the non-transmissive, non-reflective state and the first reflective state. In some implementations, the controller includes mode selection logic configured to switch between the transmissive mode and the reflective mode in response to at least one of user input, ambient light data, power source data, and host processor instruction.

In some implementations, the apparatus includes a backlight. In the transmissive mode, the light modulators transmit light emitted by the backlight in the light transmissive state, and block light emitted by the backlight in the non-transmissive, non-reflective state.

In some implementations, the array includes three light modulators to form each pixel of an image in a reflective mode of operation. Each of the three light modulators associated with a given pixel can reflect a different color. In some other implementations, the light modulators are configured to achieve at least a fourth state including a second reflective state in which the light modulator reflects a second color.

In some implementations, each light modulator includes a light obstructing component having a light absorbing surface and at least one reflective surface. In some such implementations, the light absorbing surface can include a layer of light absorbing material deposited on top of a portion of the at least one reflective surface. In some other implementations, the at least one reflective surface of each light modulator can include a corresponding color filter to reflect light of a corresponding color.

In some implementations, the at least one reflective surface includes three reflective surfaces. The at least three reflective surfaces can include a first reflective surface having a red color filter formed thereon, a second reflective surface having a green color filter formed thereon, and a third reflective surface having a blue color filter formed thereon. In some implementations, the apparatus can include a light absorbing material surrounding at least one of the at least three reflective surfaces. In some implementations, the light modulator is configured, when operating a reflective mode, to selectively transition between the non-transmissive, non-reflective state and one of three color reflective states according to a field sequential color (FSC) image formation process.

In some implementations, the apparatus can include a display which includes the array of EMS light modulators, a processor, and a memory device. The processor can be configured to communicate with the display, and to process image data. The memory device can be configured to communicate with the processor. In some implementations, the apparatus includes a driver circuit configured to send at least one signal to the display, and the processor is further configured to send at least a portion of the image data to the driver circuit. The apparatus also can include an image source module configured to send the image data to the processor. The image source module can include at least one of a receiver, transceiver, and transmitter. The apparatus, in some implementations, includes an input device configured to receive input data and to communicate the input data to the processor.

Another innovative aspect of the subject matter described in this disclosure can be implemented in an apparatus that includes an array of light modulating means. Each light modulating means can be transitioned between three separate states, including a non-transmissive, non-reflective state, a light transmissive state in which the light modulating means transmits light, and a first reflective state, in which the light modulating means reflects a color.

In some implementations, the light modulating means is configured to transition between the non-transmissive, non-reflective state and the light transmissive state through movement in a first direction having a first axis of motion and to transition between the non-transmissive, non-reflective state and the first reflective state through movement in a second direction having a second, different axis of motion. In some such implementations, the first axis of motion is substantially perpendicular to the second axis of motion. In some other implementations, the light modulating means is configured to transition between the non-transmissive, non-reflective state and the light transmissive state through movement of a first distance in a first direction and to transition between the non-transmissive, non-reflective state and the first reflective state through movement of a second, greater distance in the first direction.

In some implementations, the apparatus can include a means for controlling the array of light modulating means in both a transmissive mode and in a reflective mode. In the transmissive mode, the controlling means can be configured to cause the light modulating means in the array to be selectively driven between the non-transmissive, non-reflective state and the light transmissive state. In the reflective mode, the controlling means can be configured to cause the light modulators in the array to be selectively driven between the non-transmissive, non-reflective state and the first reflective state.

In some implementations, the apparatus can include a light emitting means. In the transmissive mode, the light modulating means transmit light emitted by the light emitting means in the light transmissive state, and block light emitted by the light emitting means in the non-transmissive state.

In some implementations, the array includes three light modulating means to form each pixel of an image in a reflective mode of operation, and each of the three light modulating means associated with a given pixel can reflect a different color. In some other implementations, the light modulating means can be configured to achieve at least a fourth state including a second reflective state in which the light modulating means reflects a second color.

In some implementations, each light modulating means includes a means for absorbing light and means for reflecting light. In some such implementations, the reflecting means includes a color selection means for limiting the color of light reflected by the reflecting means. In some such implementations, the reflecting means includes color selection means for separately reflecting three different colors.

Details of one or more implementations of the subject matter described in this specification are set forth in the accompanying drawings and the description below. Although the examples provided in this summary are primarily described in terms of MEMS-based displays, the concepts provided herein may apply to other types of displays, such as liquid crystal displays (LCDs), organic light emitting diode (OLED) displays, electrophoretic displays, and field emission displays, as well as to other non-display MEMS devices, such as MEMS microphones, sensors, and optical switches. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIG. 2 shows a perspective view of an example shutter-based light modulator.

FIG. 3A shows a schematic diagram of an example control matrix.

FIG. 3B shows a perspective view of an example array of shutter-based light modulators connected to the control matrix of FIG. 3A.

FIGS. 4A and 4B show views of an example dual actuator shutter assembly.

FIG. 5 shows a cross sectional view of an example display apparatus incorporating shutter-based light modulators.

FIG. 6 shows a cross sectional view of an example light modulator substrate and an example aperture plate for use in a MEMS-down configuration of a display.

FIGS. 7A-7F show various example views of a dual-mode display apparatus and components thereof.

FIGS. 8A-8D show various example views of another dual-mode display apparatus and components thereof.

FIGS. 9A-9G show various example views of a dual-mode display apparatus and components thereof.

FIGS. 10A-10C show example isometric views of a dual-mode display apparatus.

FIGS. 11A-11E show example plan views of another dual-mode display apparatus.

FIG. 12 shows a plan view of an example shutter assembly suitable for use in the display apparatus shown in FIGS. 7B-7F.

FIG. 13 shows a plan view of an example shutter assembly suitable for use in the display apparatus shown in FIGS. 10A-10C.

FIGS. 14 and 15 show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (such as e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In order to provide high quality color images in both indoor and outdoor ambient lighting conditions, a transflective display can include light modulators that can operate in both a field sequential color (FSC) transmissive operating mode and a color reflective operating mode. Moreover, in some implementations, the light modulators are configured, when operating in a reflective mode, to reflect specific colors of light to enable the formation of color images. In some implementations, each modulator can reflect more than one color of light and is addressed according to a FSC image formation process. In some other implementations, light modulators reflecting different colors can be grouped together to form a single pixel.

In some implementations, the light modulators are shutters that can be actuated along at least two axes. Actuation along one axis transitions the shutter between a light transmissive state and a light blocking state. In the light transmissive state, the shutter allows light to pass by or through the shutter to contribute to the formation of an image. In the light blocking state, the shutter blocks light emanating from a backlight and absorbs incident ambient light. While in the light blocking state, actuation along a second axis moves the shutter into a reflecting state. For shutters configured for reflecting multiple colors, the particular color being reflected can be selected by providing additional actuation states along either the first or second axes.

In some other implementations, the light modulators are shutters that can be actuated through transmissive, light blocking, and one or more reflective states through movement along a single axis. In one such implementation, the shutter can be actuated from a light absorbing rest state into a light reflecting state in one direction and into a light absorbing state in the opposing direction. In some other implementations, the shutter is configured to have the light reflecting or transmissive states as its rest state, and the shutter is moved along the first axis into its other possible states by applying an variable actuation voltage to an actuator coupled to the shutter.

Particular implementations of the subject matter described in this disclosure can be implemented to realize one or more of the following potential advantages. By employing shutters that can take on light absorbing, light transmissive, and light reflecting states, a display apparatus can generate color images in both a transmissive mode and a reflective mode. As a result, the display apparatus can provide full color images and video in a wide range of ambient lighting conditions.

By incorporating shutters including multiple light reflective portions corresponding to different colors, a display can generate images in the reflective mode according to a FSC imaging process. This allows the display to maintain the same resolution in both modes of operation. It also reduces the number of imaging algorithms needed to be stored and implemented on a device, as similar algorithms can be used for both reflective and transmissive modes of operation. In some implementations, each of the light reflective portions is surrounded by a light absorbing portion, increasing the alignment tolerance of components of the display.

In some implementations, the shutters have a rest state that is light absorbing, and only a single actuator is needed in each mode to move the shutter into its appropriate state. This configuration reduces the power needed to operate the display, because fewer actuators need to be addressed and actuated for each shutter.

In some implementations, the display apparatus can include mode selection logic which is configured to switch between the transmissive and reflective modes of operation based on at least one of user input, ambient light data, power source data, and host processor instructions. As a result, the display apparatus can be responsive to the current needs and demands of a user, host device, or application executing on the host device, which may change over time.

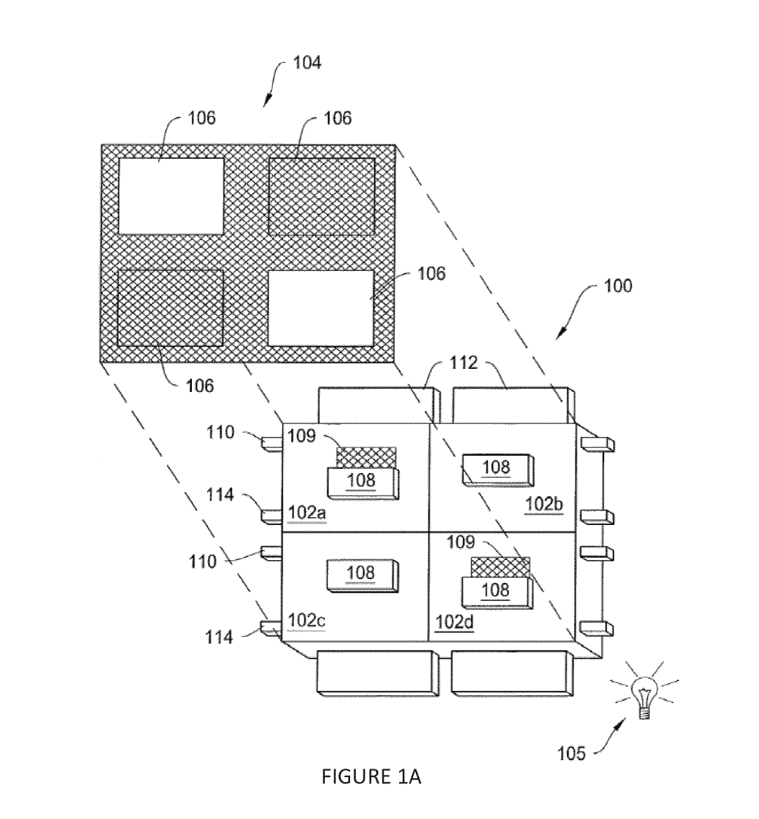

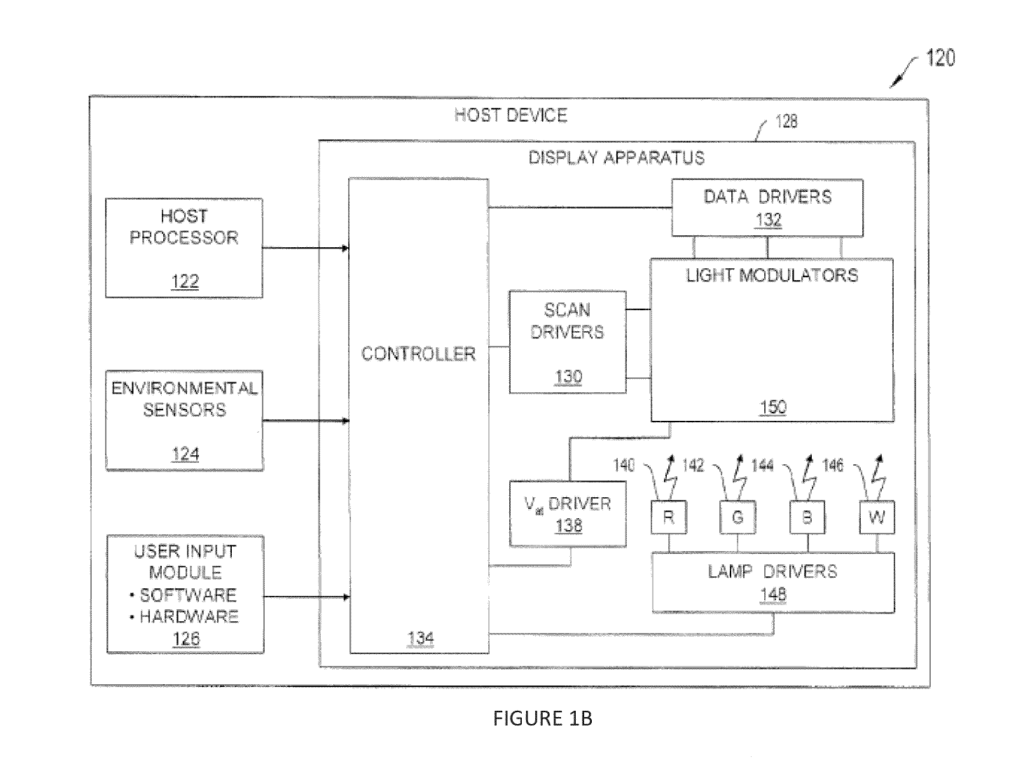

FIG. 1A shows a schematic diagram of an example direct-view MEMS-based display apparatus 100. The display apparatus 100 includes a plurality of light modulators 102a-102d (generally “light modulators 102”) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide luminance level in an image 104. With respect to an image, a “pixel” corresponds to the smallest picture element defined by the resolution of image. With respect to structural components of the display apparatus 100, the term “pixel” refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the user sees the image by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or “backlight” so that each pixel can be uniformly illuminated. Transmissive direct-view displays are often built onto transparent or glass substrates to facilitate a sandwich assembly arrangement where one substrate, containing the light modulators, is positioned directly on top of the backlight.

Each light modulator 102 can include a shutter 108 and an aperture 109. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix connected to the substrate and to the light modulators for controlling the movement of the shutters. The control matrix includes a series of electrical interconnects (such as interconnects 110, 112 and 114), including at least one write-enable interconnect 110 (also referred to as a “scan-line interconnect”) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the “write-enabling voltage, V_{WE}”), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate actuation voltages, which are typically higher in magnitude than the data voltages, to the light modulators 102. The application of these actuation voltages then results in the electrostatic driven movement of the shutters 108.

FIG. 1B shows a block diagram of an example host device 120 (i.e., cell phone, smart phone, PDA, MP3 player, tablet, e-reader, netbook, notebook, etc.). The host device 120 includes a display apparatus 128, a host processor 122, environmental sensors 124, a user input module 126, and a power source.

The display apparatus 128 includes a plurality of scan drivers 130 (also referred to as “write enabling voltage sources”), a plurality of data drivers 132 (also referred to as “data voltage sources”), a controller 134, common drivers 138, lamps 140-146, lamp drivers 148 and an array 150 of display elements, such as the light modulators 102 shown in FIG. 1A. The scan drivers 130 apply write enabling voltages to scan-line interconnects 110. The data drivers 132 apply data voltages to the data interconnects 112.

In some implementations of the display apparatus, the data drivers 132 are configured to provide analog data voltages to the array 150 of display elements, especially where the luminance level of the image 104 is to be derived in analog fashion. In analog operation, the light modulators 102 are designed such that when a range of intermediate voltages is applied through the data interconnects 112, there results a range of intermediate open states in the shutters 108 and therefore a range of intermediate illumination states or luminance levels in the image 104. In other cases, the data drivers 132 are configured to apply only a reduced set of 2, 3 or 4 digital voltage levels to the data interconnects 112. These voltage levels are designed to set, in digital fashion, an open state, a closed state, or other discrete state to each of the shutters 108.

The scan drivers 130 and the data drivers 132 are connected to a digital controller circuit 134 (also referred to as the “controller 134”). The controller sends data to the data drivers 132 in a mostly serial fashion, organized in predetermined sequences grouped by rows and by image frames. The data drivers 132 can include series to parallel data converters, level shifting, and for some applications digital to analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 114. In some other implementations, the common drivers 138, following commands from the controller 134, issue voltage pulses or signals to the array 150 of display elements, for instance global actuation pulses which are capable of driving and/or initiating simultaneous actuation of all display elements in multiple rows and columns of the array 150.

All of the drivers (such as scan drivers 130, data drivers 132 and common drivers 138) for different display functions are time-synchronized by the controller 134. Timing commands from the controller coordinate the illumination of red, green and blue and white lamps (140, 142, 144 and 146 respectively) via lamp drivers 148, the write-enabling and sequencing of specific rows within the array 150 of display elements, the output of voltages from the data drivers 132, and the output of voltages that provide for display element actuation. In some implementations, the lamps are light emitting diodes (LEDs).

The controller 134 determines the sequencing or addressing scheme by which each of the shutters 108 can be re-set to the illumination levels appropriate to a new image 104. New images 104 can be set at periodic intervals. For instance, for video displays, the color images 104 or frames of video are refreshed at frequencies ranging from 10 to 300 Hertz (Hz). In some implementations the setting of an image frame to the array 150 is synchronized with the illumination of the lamps 140, 142, 144 and 146 such that alternate image frames are illuminated with an alternating series of colors, such as red, green, and blue. The image frames for each respective color is referred to as a color subframe. In this method, referred to as the field sequential color method, if the color subframes are alternated at frequencies in excess of 20 Hz, the human brain will average the alternating frame images into the perception of an image having a broad and continuous range of colors. In alternate implementations, four or more lamps with primary colors can be employed in display apparatus 100, employing primaries other than red, green, and blue.

In some implementations, where the display apparatus 100 is designed for the digital switching of shutters 108 between open and closed states, the controller 134 forms an image by the method of time division gray scale, as previously described. In some other implementations, the display apparatus 100 can provide gray scale through the use of multiple shutters 108 per pixel.

In some implementations, the data for an image state 104 is loaded by the controller 134 to the display element array 150 by a sequential addressing of individual rows, also referred to as scan lines. For each row or scan line in the sequence, the scan driver 130 applies a write-enable voltage to the write enable interconnect 110 for that row of the array 150, and subsequently the data driver 132 supplies data voltages, corresponding to desired shutter states, for each column in the selected row. This process repeats until data has been loaded for all rows in the array 150. In some implementations, the sequence of selected rows for data loading is linear, proceeding from top to bottom in the array 150. In some other implementations, the sequence of selected rows is pseudo-randomized, in order to minimize visual artifacts. And in some other implementations the sequencing is organized by blocks, where, for a block, the data for only a certain fraction of the image state 104 is loaded to the array 150, for instance by addressing only every 5^{th} row of the array 150 in sequence.

In some implementations, the process for loading image data to the array 150 is separated in time from the process of actuating the display elements in the array 150. In these implementations, the display element array 150 may include data memory elements for each display element in the array 150 and the control matrix may include a global actuation interconnect for carrying trigger signals, from common driver 138, to initiate simultaneous actuation of shutters 108 according to data stored in the memory elements.

In alternative implementations, the array 150 of display elements and the control matrix that controls the display elements may be arranged in configurations other than rectangular rows and columns. For example, the display elements can be arranged in hexagonal arrays or curvilinear rows and columns. In general, as used herein, the term scan-line shall refer to any plurality of display elements that share a write-enabling interconnect.

As described above, in some implementations, the display apparatus 100 is configured to operate in both a backlit transmissive mode and in a reflective mode. Accordingly, the controller 134 can include mode selection logic 135. The mode selection logic 135 is configured to identify the appropriate operating mode for the display apparatus 100. In some implementations, the mode selection logic 135 take as input one or more of ambient light data received from environmental sensors 124, user input from the user input module 126, application data from an application executing on the host processor 122, other host processor 122 instructions, and battery level data for the host device 120. For example, the mode selection logic 135 may determine that the display apparatus 100 is to operate in a reflective mode in response to detecting high levels of ambient light (e.g., as may be present in outdoor operating environments), low battery levels in combination with a sufficient amount of ambient light to form an image through reflections, or an express user or application instruction to operate in the reflective mode.

The host processor 122 generally controls the operations of the host. For example, the host processor 122 may be a general or special purpose processor for controlling a portable electronic device. With respect to the display apparatus 128, included within the host device 120, the host processor 122 outputs image data as well as additional data about the host. Such information may include data from environmental sensors, such as ambient light or temperature; information about the host, including, for example, an operating mode of the host or the amount of power remaining in the host's power source; information about the content of the image data; information about the type of image data; and/or instructions for display apparatus for use in selecting an imaging mode.

The user input module 126 conveys the personal preferences of the user to the controller 134, either directly, or via the host processor 122. In some implementations, the user input module 126 is controlled by software in which the user programs personal preferences such as “deeper color,” “better contrast,” “lower power,” “increased brightness,” “sports,” “live action,” or “animation.” In some other implementations, these preferences are input to the host using hardware, such as a switch or dial. The plurality of data inputs to the controller 134 direct the controller to provide data to the various drivers 130, 132, 138 and 148 which correspond to optimal imaging characteristics.

An environmental sensor module 124 also can be included as part of the host device 120. The environmental sensor module 124 receives data about the ambient environment, such as temperature and or ambient lighting conditions. The sensor module 124 can be programmed to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

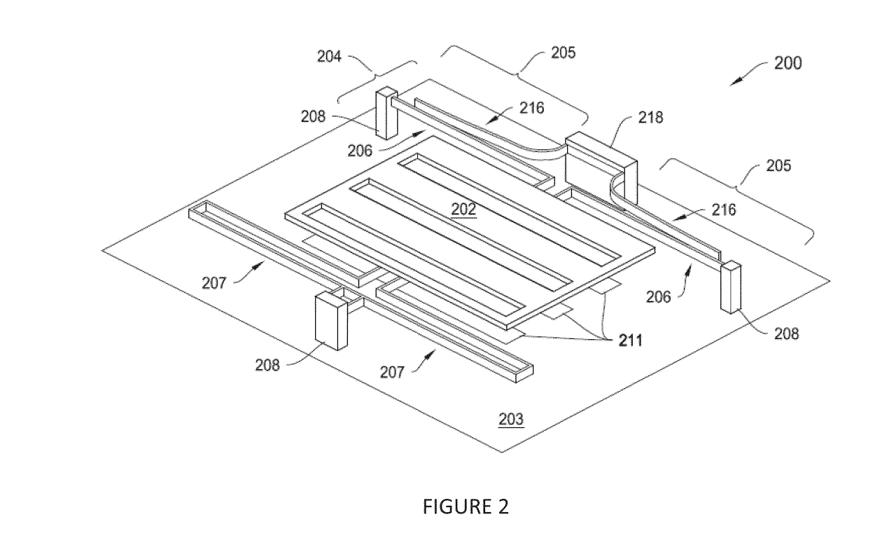

FIG. 2 shows a perspective view of an example shutter-based light modulator 200. The shutter-based light modulator 200 is suitable for incorporation into the direct-view MEMS-based display apparatus 100 of FIG. 1A. The light modulator 200 includes a shutter 202 coupled to an actuator 204. The actuator 204 can be formed from two separate compliant electrode beam actuators 205 (the “actuators 205”). The shutter 202 couples on one side to the actuators 205. The actuators 205 move the shutter 202 transversely over a surface 203 in a plane of motion which is substantially parallel to the surface 203. The opposite side of the shutter 202 couples to a spring 207 which provides a restoring force opposing the forces exerted by the actuator 204.

Each actuator 205 includes a compliant load beam 206 connecting the shutter 202 to a load anchor 208. The load anchors 208 along with the compliant load beams 206 serve as mechanical supports, keeping the shutter 202 suspended proximate to the surface 203. The surface 203 includes one or more aperture holes 211 for admitting the passage of light. The load anchors 208 physically connect the compliant load beams 206 and the shutter 202 to the surface 203 and electrically connect the load beams 206 to a bias voltage, in some instances, ground.

If the substrate is opaque, such as silicon, then aperture holes 211 are formed in the substrate by etching an array of holes through the substrate 204. If the substrate 204 is transparent, such as glass or plastic, then the aperture holes 211 are formed in a layer of light-blocking material deposited on the substrate 203. The aperture holes 211 can be generally circular, elliptical, polygonal, serpentine, or irregular in shape.

Each actuator 205 also includes a compliant drive beam 216 positioned adjacent to each load beam 206. The drive beams 216 couple at one end to a drive beam anchor 218 shared between the drive beams 216. The other end of each drive beam 216 is free to move. Each drive beam 216 is curved such that it is closest to the load beam 206 near the free end of the drive beam 216 and the anchored end of the load beam 206.

In operation, a display apparatus incorporating the light modulator 200 applies an electric potential to the drive beams 216 via the drive beam anchor 218. A second electric potential may be applied to the load beams 206. The resulting potential difference between the drive beams 216 and the load beams 206 pulls the free ends of the drive beams 216 towards the anchored ends of the load beams 206, and pulls the shutter ends of the load beams 206 toward the anchored ends of the drive beams 216, thereby driving the shutter 202 transversely toward the drive anchor 218. The compliant members 206 act as springs, such that when the voltage across the beams 206 and 216 potential is removed, the load beams 206 push the shutter 202 back into its initial position, releasing the stress stored in the load beams 206.

A light modulator, such as the light modulator 200, incorporates a passive restoring force, such as a spring, for returning a shutter to its rest position after voltages have been removed. Other shutter assemblies can incorporate a dual set of “open” and “closed” actuators and a separate set of “open” and “closed” electrodes for moving the shutter into either an open or a closed state.

There are a variety of methods by which an array of shutters and apertures can be controlled via a control matrix to produce images, in many cases moving images, with appropriate luminance levels. In some cases, control is accomplished by means of a passive matrix array of row and column interconnects connected to driver circuits on the periphery of the display. In other cases it is appropriate to include switching and/or data storage elements within each pixel of the array (the so-called active matrix) to improve the speed, the luminance level and/or the power dissipation performance of the display.

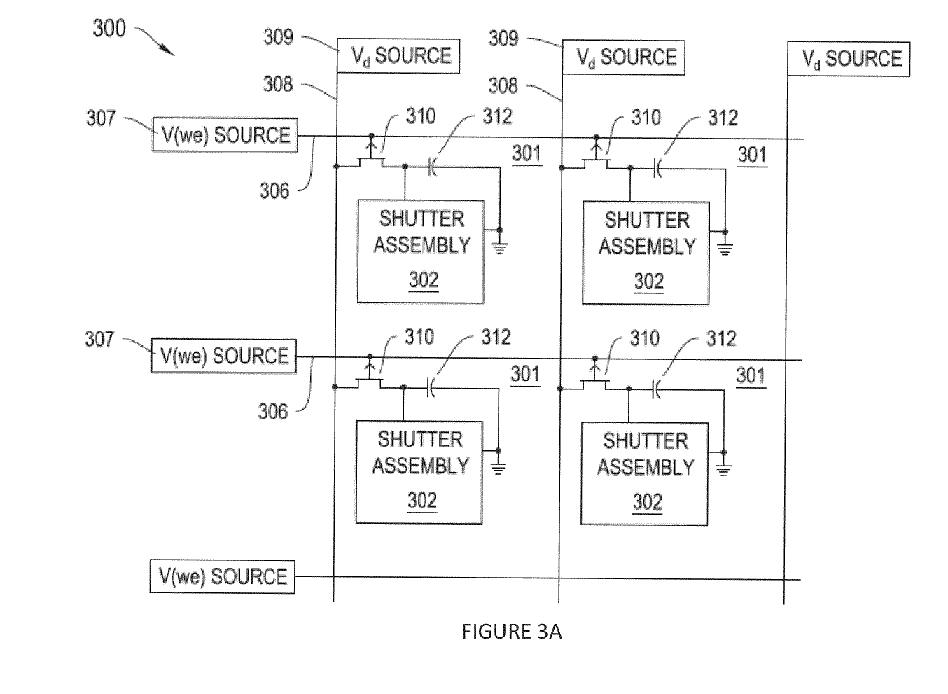

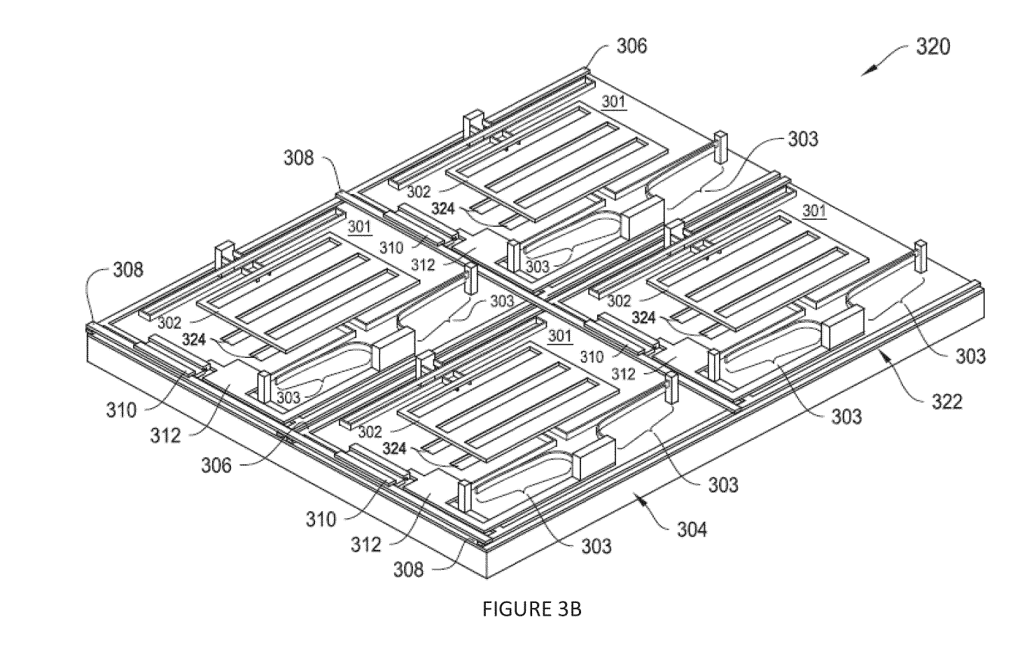

FIG. 3A shows a schematic diagram of an example control matrix 300. The control matrix 300 is suitable for controlling the light modulators incorporated into the MEMS-based display apparatus 100 of FIG. 1A. FIG. 3B shows a perspective view of an example array 320 of shutter-based light modulators connected to the control matrix 300 of FIG. 3A. The control matrix 300 may address an array of pixels 320 (the “array 320”). Each pixel 301 can include an elastic shutter assembly 302, such as the shutter assembly 200 of FIG. 2, controlled by an actuator 303. Each pixel also can include an aperture layer 322 that includes apertures 324.

The control matrix 300 is fabricated as a diffused or thin-film-deposited electrical circuit on the surface of a substrate 304 on which the shutter assemblies 302 are formed. The control matrix 300 includes a scan-line interconnect 306 for each row of pixels 301 in the control matrix 300 and a data-interconnect 308 for each column of pixels 301 in the control matrix 300. Each scan-line interconnect 306 electrically connects a write-enabling voltage source 307 to the pixels 301 in a corresponding row of pixels 301. Each data interconnect 308 electrically connects a data voltage source 309 (“V_{d} source”) to the pixels 301 in a corresponding column of pixels. In the control matrix 300, the V_{d} source 309 provides the majority of the energy to be used for actuation of the shutter assemblies 302. Thus, the data voltage source, V_{d} source 309, also serves as an actuation voltage source.

Referring to FIGS. 3A and 3B, for each pixel 301 or for each shutter assembly 302 in the array of pixels 320, the control matrix 300 includes a transistor 310 and a capacitor 312. The gate of each transistor 310 is electrically connected to the scan-line interconnect 306 of the row in the array 320 in which the pixel 301 is located. The source of each transistor 310 is electrically connected to its corresponding data interconnect 308. The actuators 303 of each shutter assembly 302 include two electrodes. The drain of each transistor 310 is electrically connected in parallel to one electrode of the corresponding capacitor 312 and to one of the electrodes of the corresponding actuator 303. The other electrode of the capacitor 312 and the other electrode of the actuator 303 in shutter assembly 302 are connected to a common or ground potential. In alternate implementations, the transistors 310 can be replaced with semiconductor diodes and or metal-insulator-metal sandwich type switching elements.

In operation, to form an image, the control matrix 300 write-enables each row in the array 320 in a sequence by applying V_{we} to each scan-line interconnect 306 in turn. For a write-enabled row, the application of V, to the gates of the transistors 310 of the pixels 301 in the row allows the flow of current through the data interconnects 308 through the transistors 310 to apply a potential to the actuator 303 of the shutter assembly 302. While the row is write-enabled, data voltages V_{d} are selectively applied to the data interconnects 308. In implementations providing analog gray scale, the data voltage applied to each data interconnect 308 is varied in relation to the desired brightness of the pixel 301 located at the intersection of the write-enabled scan-line interconnect 306 and the data interconnect 308. In implementations providing digital control schemes, the data voltage is selected to be either a relatively low magnitude voltage (i.e., a voltage near ground) or to meet or exceed Vₐₜ (the actuation threshold voltage). In response to the application of Vₐₜ to a data interconnect 308, the actuator 303 in the corresponding shutter assembly actuates, opening the shutter in that shutter assembly 302. The voltage applied to the data interconnect 308 remains stored in the capacitor 312 of the pixel 301 even after the control matrix 300 ceases to apply V_{we} to a row. Therefore, the voltage V_{we} does not have to wait and hold on a row for times long enough for the shutter assembly 302 to actuate; such actuation can proceed after the write-enabling voltage has been removed from the row. The capacitors 312 also function as memory elements within the array 320, storing actuation instructions for the illumination of an image frame.

The pixels 301 as well as the control matrix 300 of the array 320 are formed on a substrate 304. The array 320 includes an aperture layer 322, disposed on the substrate 304, which includes a set of apertures 324 for respective pixels 301 in the array 320. The apertures 324 are aligned with the shutter assemblies 302 in each pixel. In some implementations, the substrate 304 is made of a transparent material, such as glass or plastic. In some other implementations, the substrate 304 is made of an opaque material, but in which holes are etched to form the apertures 324.

The shutter assembly 302 together with the actuator 303 can be made bi-stable. That is, the shutters can exist in at least two equilibrium positions (such as open or closed) with little or no power required to hold them in either position. More particularly, the shutter assembly 302 can be mechanically bi-stable. Once the shutter of the shutter assembly 302 is set in position, no electrical energy or holding voltage is required to maintain that position. The mechanical stresses on the physical elements of the shutter assembly 302 can hold the shutter in place.

The shutter assembly 302 together with the actuator 303 also can be made electrically bi-stable. In an electrically bi-stable shutter assembly, there exists a range of voltages below the actuation voltage of the shutter assembly, which if applied to a closed actuator (with the shutter being either open or closed), holds the actuator closed and the shutter in position, even if an opposing force is exerted on the shutter. The opposing force may be exerted by a spring such as the spring 207 in the shutter-based light modulator 200 depicted in FIG. 2, or the opposing force may be exerted by an opposing actuator, such as an “open” or “closed” actuator.

The light modulator array 320 is depicted as having a single MEMS light modulator per pixel. Other implementations are possible in which multiple MEMS light modulators are provided in each pixel, thereby providing the possibility of more than just binary “on’ or “off” optical states in each pixel. Certain forms of coded area division gray scale are possible where multiple MEMS light modulators in the pixel are provided, and where apertures 324, which are associated with each of the light modulators, have unequal areas.

In some other implementations, other MEMS-based light modulators, can be substituted for the shutter assembly 302 within the light modulator array 320.

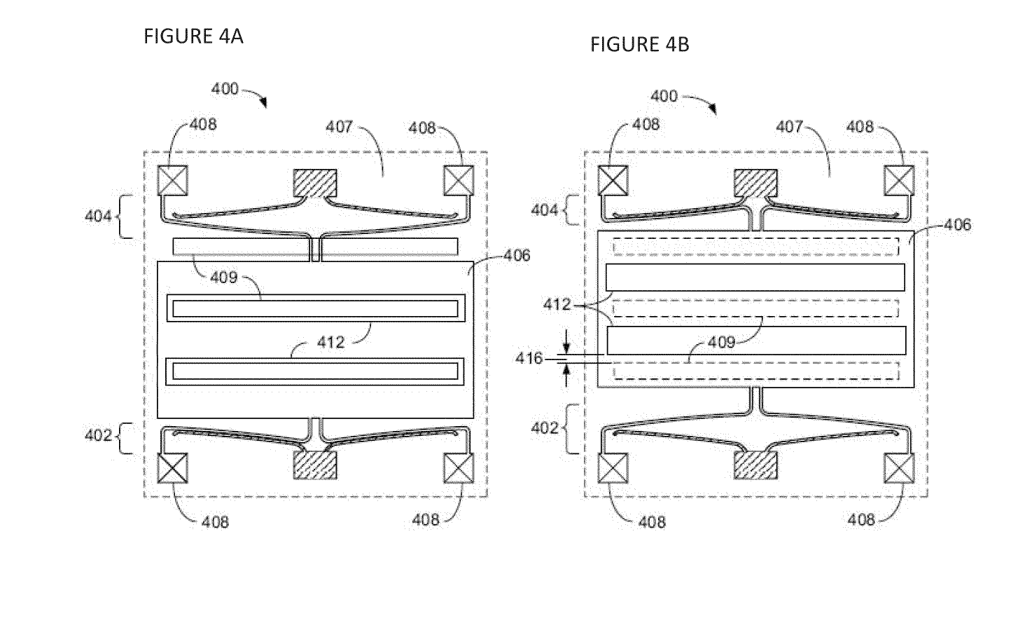

FIGS. 4A and 4B show views of an example dual actuator shutter assembly 400. The dual actuator shutter assembly 400, as depicted in FIG. 4A, is in an open state. FIG. 4B shows the dual actuator shutter assembly 400 in a closed state. In contrast to the shutter assembly 200, the shutter assembly 400 includes actuators 402 and 404 on either side of a shutter 406. Each actuator 402 and 404 is independently controlled. A first actuator, a shutter-open actuator 402, serves to open the shutter 406. A second opposing actuator, the shutter-close actuator 404, serves to close the shutter 406. Both of the actuators 402 and 404 are compliant beam electrode actuators. The actuators 402 and 404 open and close the shutter 406 by driving the shutter 406 substantially in a plane parallel to an aperture layer 407 over which the shutter is suspended. The shutter 406 is suspended a short distance over the aperture layer 407 by anchors 408 attached to the actuators 402 and 404. The inclusion of supports attached to both ends of the shutter 406 along its axis of movement reduces out of plane motion of the shutter 406 and confines the motion substantially to a plane parallel to the substrate. By analogy to the control matrix 300 of FIG. 3A, a control matrix suitable for use with the shutter assembly 400 might include one transistor and one capacitor for each of the opposing shutter-open and shutter-close actuators 402 and 404.

The shutter 406 includes two shutter apertures 412 through which light can pass. The aperture layer 407 includes a set of three apertures 409. In FIG. 4A, the shutter assembly 400 is in the open state and, as such, the shutter-open actuator 402 has been actuated, the shutter-close actuator 404 is in its relaxed position, and the centerlines of the shutter apertures 412 coincide with the centerlines of two of the aperture layer apertures 409. In FIG. 4B the shutter assembly 400 has been moved to the closed state and, as such, the shutter-open actuator 402 is in its relaxed position, the shutter-close actuator 404 has been actuated, and the light blocking portions of the shutter 406 are now in position to block transmission of light through the apertures 409 (depicted as dotted lines).

Each aperture has at least one edge around its periphery. For example, the rectangular apertures 409 have four edges. In alternative implementations in which circular, elliptical, oval, or other curved apertures are formed in the aperture layer 407, each aperture may have only a single edge. In some other implementations, the apertures need not be separated or disjoint in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through apertures 412 and 409 in the open state, it is advantageous to provide a width or size for shutter apertures 412 which is larger than a corresponding width or size of apertures 409 in the aperture layer 407. In order to effectively block light from escaping in the closed state, it is preferable that the light blocking portions of the shutter 406 overlap the apertures 409. FIG. 4B shows a predefined overlap 416 between the edge of light blocking portions in the shutter 406 and one edge of the aperture 409 formed in the aperture layer 407.

The electrostatic actuators 402 and 404 are designed so that their voltage-displacement behavior provides a bi-stable characteristic to the shutter assembly 400. For each of the shutter-open and shutter-close actuators there exists a range of voltages below the actuation voltage, which if applied while that actuator is in the closed state (with the shutter being either open or closed), will hold the actuator closed and the shutter in position, even after an actuation voltage is applied to the opposing actuator. The minimum voltage needed to maintain a shutter's position against such an opposing force is referred to as a maintenance voltage Vₘ.

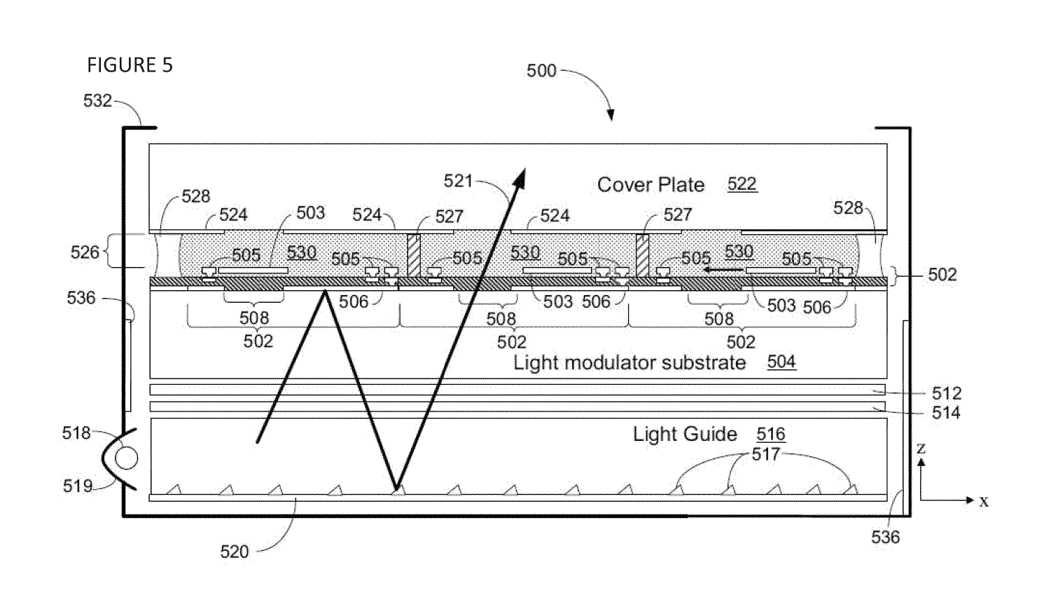

FIG. 5 shows a cross sectional view of an example display apparatus 500 incorporating shutter-based light modulators (shutter assemblies) 502. Each shutter assembly 502 incorporates a shutter 503 and an anchor 505. Not shown are the compliant beam actuators which, when connected between the anchors 505 and the shutters 503, help to suspend the shutters 503 a short distance above the surface. The shutter assemblies 502 are disposed on a transparent substrate 504, such a substrate made of plastic or glass. A rear-facing reflective layer, reflective film 506, disposed on the substrate 504 defines a plurality of surface apertures 508 located beneath the closed positions of the shutters 503 of the shutter assemblies 502. The reflective film 506 reflects light not passing through the surface apertures 508 back towards the rear of the display apparatus 500. The reflective aperture layer 506 can be a fine-grained metal film without inclusions formed in thin film fashion by a number of vapor deposition techniques including sputtering, evaporation, ion plating, laser ablation, or chemical vapor deposition (CVD). In some other implementations, the rear-facing reflective layer 506 can be formed from a mirror, such as a dielectric mirror. A dielectric mirror can be fabricated as a stack of dielectric thin films which alternate between materials of high and low refractive index. The vertical gap which separates the shutters 503 from the reflective film 506, within which the shutter is free to move, is in the range of 0.5 to 10 microns. The magnitude of the vertical gap is preferably less than the lateral overlap between the edge of shutters 503 and the edge of apertures 508 in the closed state, such as the overlap 416 depicted in FIG. 4B.

The display apparatus 500 includes an optional diffuser 512 and/or an optional brightness enhancing film 514 which separate the substrate 504 from a planar light guide 516. The light guide 516 includes a transparent, i.e., glass or plastic material. The light guide 516 is illuminated by one or more light sources 518, forming a backlight. The light sources 518 can be, for example, and without limitation, incandescent lamps, fluorescent lamps, lasers or light emitting diodes (LEDs). A reflector 519 helps direct light from lamp 518 towards the light guide 516. A front-facing reflective film 520 is disposed behind the backlight 516, reflecting light towards the shutter assemblies 502. Light rays such as ray 521 from the backlight that do not pass through one of the shutter assemblies 502 will be returned to the backlight and reflected again from the film 520. In this fashion light that fails to leave the display apparatus 500 to form an image on the first pass can be recycled and made available for transmission through other open apertures in the array of shutter assemblies 502. Such light recycling has been shown to increase the illumination efficiency of the display.

The light guide 516 includes a set of geometric light redirectors or prisms 517 which re-direct light from the lamps 518 towards the apertures 508 and hence toward the front of the display. The light redirectors 517 can be molded into the plastic body of light guide 516 with shapes that can be alternately triangular, trapezoidal, or curved in cross section. The density of the prisms 517 generally increases with distance from the lamp 518.

In some implementations, the aperture layer 506 can be made of a light absorbing material, and in alternate implementations the surfaces of shutter 503 can be coated with either a light absorbing or a light reflecting material. In some other implementations, the aperture layer 506 can be deposited directly on the surface of the light guide 516. In some implementations, the aperture layer 506 need not be disposed on the same substrate as the shutters 503 and anchors 505 (such as in the MEMS-down configuration described below).

In some implementations, the light sources 518 can include lamps of different colors, for instance, the colors red, green and blue. A color image can be formed by sequentially illuminating images with lamps of different colors at a rate sufficient for the human brain to average the different colored images into a single multi-color image. The various color-specific images are formed using the array of shutter assemblies 502. In another implementation, the light source 518 includes lamps having more than three different colors. For example, the light source 518 may have red, green, blue and white lamps, or red, green, blue and yellow lamps. In some other implementations, the light source 518 may include cyan, magenta, yellow and white lamps, red, green, blue and white lamps. In some other implementations, additional lamps may be included in the light source 518. For example, if using five colors, the light source 518 may include red, green, blue, cyan and yellow lamps. In some other implementations, the light source 518 may include white, orange, blue, purple and green lamps or white, blue, yellow, red and cyan lamps. If using six colors, the light source 518 may include red, green, blue, cyan, magenta and yellow lamps or white, cyan, magenta, yellow, orange and green lamps.

A cover plate 522 forms the front of the display apparatus 500. The rear side of the cover plate 522 can be covered with a black matrix 524 to increase contrast. In alternate implementations the cover plate includes color filters, for instance distinct red, green, and blue filters corresponding to different ones of the shutter assemblies 502. The cover plate 522 is supported a predetermined distance away from the shutter assemblies 502 forming a gap 526. The gap 526 is maintained by mechanical supports or spacers 527 and/or by an adhesive seal 528 attaching the cover plate 522 to the substrate 504.

The adhesive seal 528 seals in a fluid 530. The fluid 530 is engineered with viscosities preferably below about 10 centipoise and with relative dielectric constant preferably above about 2.0, and dielectric breakdown strengths above about 10⁴ V/cm. The fluid 530 also can serve as a lubricant. In some implementations, the fluid 530 is a hydrophobic liquid with a high surface wetting capability. In alternate implementations, the fluid 530 has a refractive index that is either greater than or less than that of the substrate 504.

Displays that incorporate mechanical light modulators can include hundreds, thousands, or in some cases, millions of moving elements. In some devices, every movement of an element provides an opportunity for static friction to disable one or more of the elements. This movement is facilitated by immersing all the parts in a fluid (also referred to as fluid 530) and sealing the fluid (such as with an adhesive) within a fluid space or gap in a MEMS display cell. The fluid 530 is usually one with a low coefficient of friction, low viscosity, and minimal degradation effects over the long term. When the MEMS-based display assembly includes a liquid for the fluid 530, the liquid at least partially surrounds some of the moving parts of the MEMS-based light modulator. In some implementations, in order to reduce the actuation voltages, the liquid has a viscosity below 70 centipoise. In some other implementations, the liquid has a viscosity below 10 centipoise. Liquids with viscosities below 70 centipoise can include materials with low molecular weights: below 4000 grams/mole, or in some cases below 400 grams/mole. Fluids 530 that also may be suitable for such implementations include, without limitation, de-ionized water, methanol, ethanol and other alcohols, paraffins, olefins, ethers, silicone oils, fluorinated silicone oils, or other natural or synthetic solvents or lubricants. Useful fluids can be polydimethylsiloxanes (PDMS), such as hexamethyldisiloxane and octamethyltrisiloxane, or alkyl methyl siloxanes such as hexylpentamethyldisiloxane. Useful fluids can be alkanes, such as octane or decane. Useful fluids can be nitroalkanes, such as nitromethane. Useful fluids can be aromatic compounds, such as toluene or diethylbenzene. Useful fluids can be ketones, such as butanone or methyl isobutyl ketone. Useful fluids can be chlorocarbons, such as chlorobenzene. Useful fluids can be chlorofluorocarbons, such as dichlorofluoroethane or chlorotrifluoroethylene. Other fluids considered for these display assemblies include butyl acetate and dimethylformamide. Still other useful fluids for these displays include hydro fluoro ethers, perfluoropolyethers, hydro fluoro poly ethers, pentanol, and butanol. Example suitable hydro fluoro ethers include ethyl nonafluorobutyl ether and 2-trifluoromethyl-3-ethoxydodecafluorohexane.

A sheet metal or molded plastic assembly bracket 532 holds the cover plate 522, the substrate 504, the backlight and the other component parts together around the edges. The assembly bracket 532 is fastened with screws or indent tabs to add rigidity to the combined display apparatus 500. In some implementations, the light source 518 is molded in place by an epoxy potting compound. Reflectors 536 help return light escaping from the edges of the light guide 516 back into the light guide 516. Not depicted in FIG. 5 are electrical interconnects which provide control signals as well as power to the shutter assemblies 502 and the lamps 518.

The display apparatus 500 is referred to as the MEMS-up configuration, wherein the MEMS based light modulators are formed on a front surface of the substrate 504, i.e., the surface that faces toward the viewer. The shutter assemblies 502 are built directly on top of the reflective aperture layer 506. In an alternate implementation, referred to as the MEMS-down configuration, the shutter assemblies are disposed on a substrate separate from the substrate on which the reflective aperture layer is formed. The substrate on which the reflective aperture layer is formed, defining a plurality of apertures, is referred to herein as the aperture plate. In the MEMS-down configuration, the substrate that carries the MEMS-based light modulators takes the place of the cover plate 522 in the display apparatus 500 and is oriented such that the MEMS-based light modulators are positioned on the rear surface of the top substrate, i.e., the surface that faces away from the viewer and toward the light guide 516. The MEMS-based light modulators are thereby positioned directly opposite to and across a gap from the reflective aperture layer 506. The gap can be maintained by a series of spacer posts connecting the aperture plate and the substrate on which the MEMS modulators are formed. In some implementations, the spacers are disposed within or between each pixel in the array. The gap or distance that separates the MEMS light modulators from their corresponding apertures is preferably less than 10 microns, or a distance that is less than the overlap between shutters and apertures, such as overlap 416.

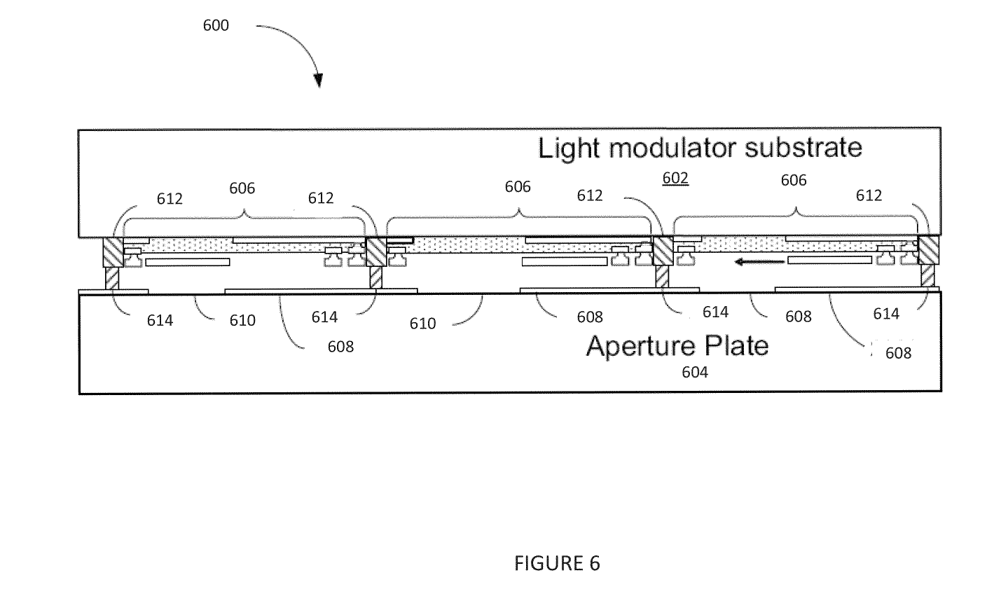

FIG. 6 shows a cross sectional view of an example light modulator substrate and an example aperture plate for use in a MEMS-down configuration of a display. The display assembly 600 includes a modulator substrate 602 and an aperture plate 604. The display assembly 600 also includes a set of shutter assemblies 606 and a reflective aperture layer 608. The reflective aperture layer 608 includes apertures 610. A predetermined gap or separation between the modulator substrates 602 and the aperture plate 604 is maintained by the opposing set of spacers 612 and 614. The spacers 612 are formed on or as part of the modulator substrate 602. The spacers 614 are formed on or as part of the aperture plate 604. During assembly, the two substrates 602 and 604 are aligned so that spacers 612 on the modulator substrate 602 make contact with their respective spacers 614.

The separation or distance of this illustrative example is 8 microns. To establish this separation, the spacers 612 are 2 microns tall and the spacers 614 are 6 microns tall. Alternately, both spacers 612 and 614 can be 4 microns tall, or the spacers 612 can be 6 microns tall while the spacers 614 are 2 microns tall. In fact, any combination of spacer heights can be employed as long as their total height establishes the desired separation H12.

Providing spacers on both of the substrates 602 and 604, which are then aligned or mated during assembly, has advantages with respect to materials and processing costs. The provision of a very tall, such as larger than 8 micron spacers, can be costly as it can require relatively long times for the cure, exposure, and development of a photo-imageable polymer. The use of mating spacers as in display assembly 600 allows for the use of thinner coatings of the polymer on each of the substrates.

In another implementation, the spacers 612 which are formed on the modulator substrate 602 can be formed from the same materials and patterning blocks that were used to form the shutter assemblies 606. For instance, the anchors employed for shutter assemblies 606 also can perform a function similar to spacer 612. In this implementation, a separate application of a polymer material to form a spacer would not be required and a separate exposure mask for the spacers would not be required.

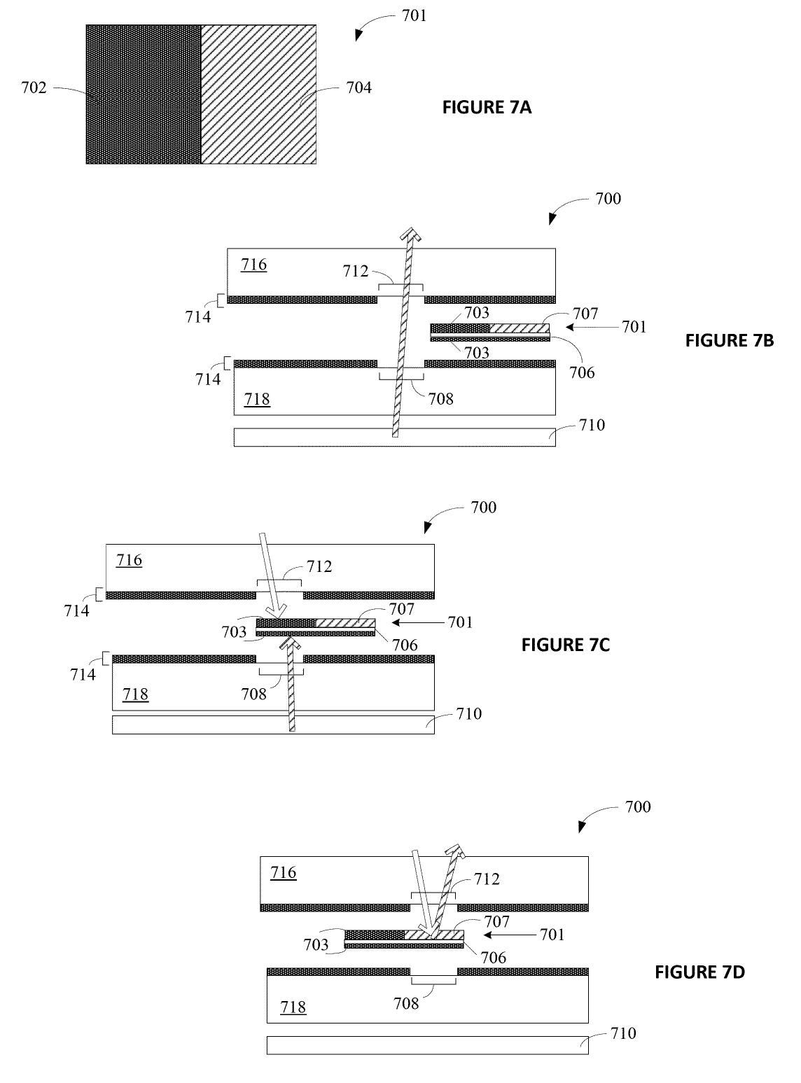

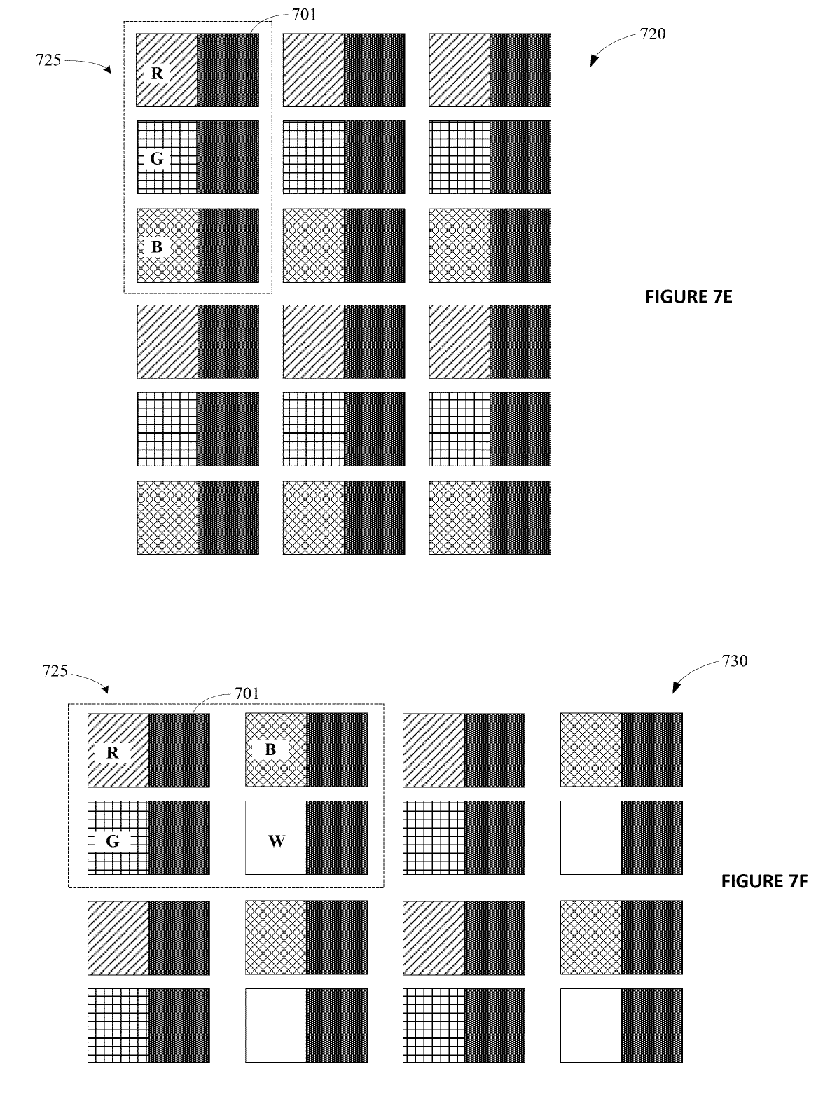

FIGS. 7A-7F show various example views of a dual-mode display apparatus 700 and components thereof. FIG. 7A shows an example plan view of a shutter 701 for use in the dual-mode display apparatus 700. FIGS. 7B-7D show example cross-sectional views of the display apparatus 700 incorporating the shutter 701 shown in FIG. 7A. FIGS. 7E and 7F show example pixel layouts 720 and 730, respectively, for the display apparatus 700 shown in FIGS. 7B-7D.

As set forth above, FIG. 7A shows an example plan view of a shutter 701 for use in a dual-mode display apparatus 700. The display apparatus 700 can operate in both a transmissive mode, in which it forms images by modulating light emitted by a backlight and in a reflective mode in which it forms images by modulating ambient light. The display apparatus 700 can switch between the two modes of operation based on user input, data received from an ambient light sensor, or instruction from an application running on a host device. To support both modes of operation, the shutter 701 includes two portions, a light absorbing portion 702 and a reflective portion 704.

Referring now to FIGS. 7A-7D, in some implementations, the light absorbing portion 702 includes a light absorbing material 703 deposited on a layer of reflective material 706 that provides the primary mechanical strength of the shutter 701. The reflective material 706 can be, for example, a reflective metal such as aluminum (Al). The light absorbing material 703 can be formed from dark metals, roughened metal, cermets, resin in which light absorbing particles are suspended, or any other substantially light absorbing material. Another layer of light absorbing material may coat the rear-facing side of the shutter 701.

The reflective portion 704 corresponds to a particular color. Accordingly, the reflective portion 704 includes a color selection structure 707 formed on the reflective material 706. The reflective material layer 706 may be a reflective metal, for example aluminum (Al) or silver (Ag), and/or a dielectric stack reflector. Alternatively, or additionally, the reflective material may be a diffuse reflector, for example, dielectric particles suspended in a matrix (such as titanium oxide (TiOx) or aluminum oxide (AlOx)). The color selection structure 707 limits the color of the light reflected to a desired color, such as red, green, blue, or white. In some other implementations, the color selection structure 707 limits the color of the light reflected from the reflective portion 704 of the shutter 701 to other colors, such as, cyan, yellow, or magenta. The color selection structure can be a typical resin color filter, a diffraction grating, or any other structure that selectively passes light of a desired color.

While the shutter 701 described above is described as having a reflective material 706 as the primary structural material, in other implementations, the primary structural material of the shutter 701 is a light absorbing material. In such implementations, the reflective portion 704 is formed by depositing and patterning a layer of reflective material on top of the light absorbing material.

Referring to FIGS. 7B-7D, the shutter 701 can be driven along a single axis into at least three different states. In each state, the shutter 701 obtains a different position relative to a pair of opposing apertures. A rear aperture 708 is positioned between a backlight 710 and the shutter 701. A front aperture 712 is positioned between the shutter 701 and the front of the display apparatus 700. In some implementations, the apertures 708 and 712 are patterned into layers of light absorbing material 714 deposited on front and rear substrates 716 and 718, respectively.

In some implementations, the display apparatus 700 is built having a MEMS-up configuration as shown in FIG. 5. In such implementations, the front substrate 716 serves as a cover plate for the display apparatus 700 and the shutter 701 is fabricated as part of a shutter assembly on the rear substrate 718. In some other implementations, the display apparatus 700 is built having a MEMS-down configuration as shown in FIG. 6. In such implementations, the shutter 701 is fabricated as part of a shutter assembly formed on the front substrate 716, and the rear substrate 718 serves as an aperture plate.

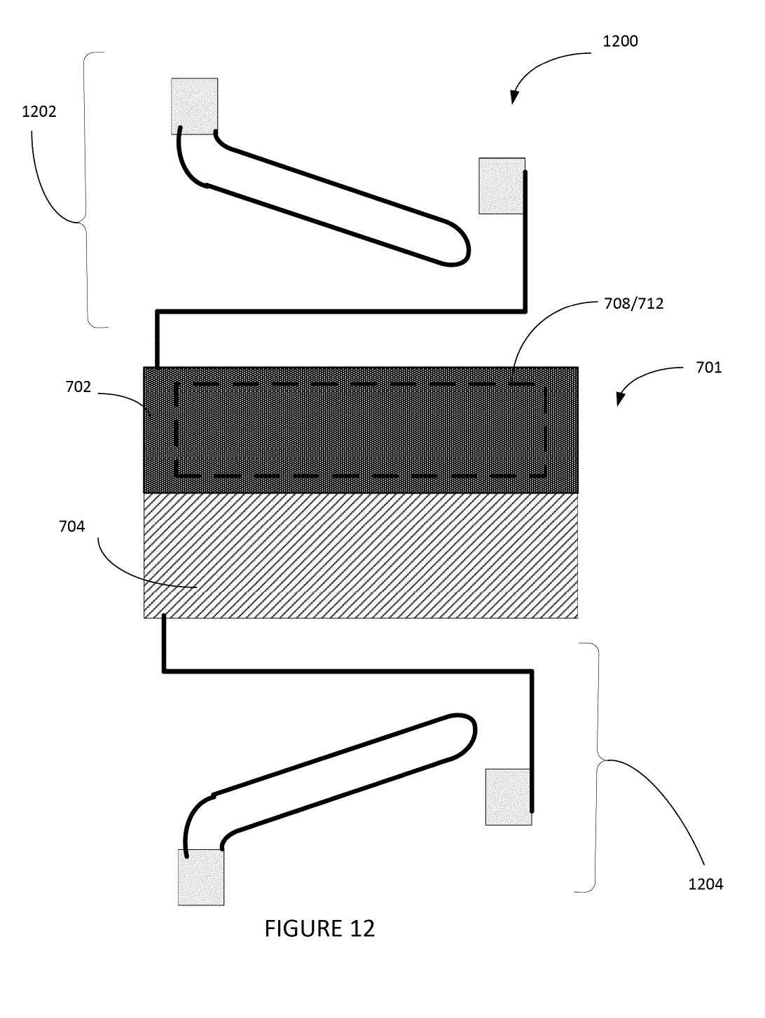

In FIGS. 7A-7F, the remainder of the shutter assembly of which the shutter 701 is a part is excluded for ease of explanation. A suitable shutter assembly architecture, including an example actuator architecture suitable for moving the shutter 701 between its three possible states, is shown in FIG. 12, which is described below.

In a transmissive mode of operation, the backlight 710 emits light through the rear aperture 708 towards the front aperture 712 and the front of the display apparatus 700. The display apparatus 700 modulates this light by selectively moving the shutter 701 between a transmissive state in which the shutter 701 does not obstruct the path of light through the apertures (shown in FIG. 7A) to a light blocking state (shown in FIG. 7B). In the light blocking state, the light blocking portion 702 of the shutter 701 is positioned directly between the front and rear apertures 708 and 712. In this state, the shutter 701 blocks light emitted by the backlight 710 and absorbs ambient light received from beyond the front of the display apparatus 700. In some implementations, the backlight 710 alternates between emitting light of different colors according to a field sequential color (FSC) image formation process.

In a reflective mode, the backlight 710 is turned off. Instead, the display apparatus 700 modulates ambient light. In this mode, the display selectively moves the shutter 701 between the light blocking state (shown in FIG. 7B) to a light reflecting state (shown in FIG. 7C). In the light reflecting state, the shutter 701 is positioned such that the light reflecting portion 704 is positioned directly between the front and rear apertures 708 and 712.

FIG. 7E shows a first example pixel layout 720 for the display apparatus 700. In the transmissive mode, a single shutter 701 can modulate multiple colors of light sequentially using a FSC image formation process; however, each shutter 701 is configured to reflect only a single color. Thus, to form a full color image in the reflective mode, the pixel layout 720 includes three shutters 701 for each pixel 725 addressed by the display apparatus. Each shutter 701 in a pixel 725 reflects a different primary color, such as red, green, and blue. In some implementations, in the transmissive mode, the display apparatus 700 can address each group of three shutters collectively, such that they either all open or all close together. In some other implementations, the display apparatus 700 can address each shutter 701 independently to provide increased resolution.

FIG. 7F shows a second example pixel layout 730 for the display apparatus 700. The pixel layout 730 includes a fourth shutter 701 for each pixel 735. The fourth shutter 70 reflects white light.

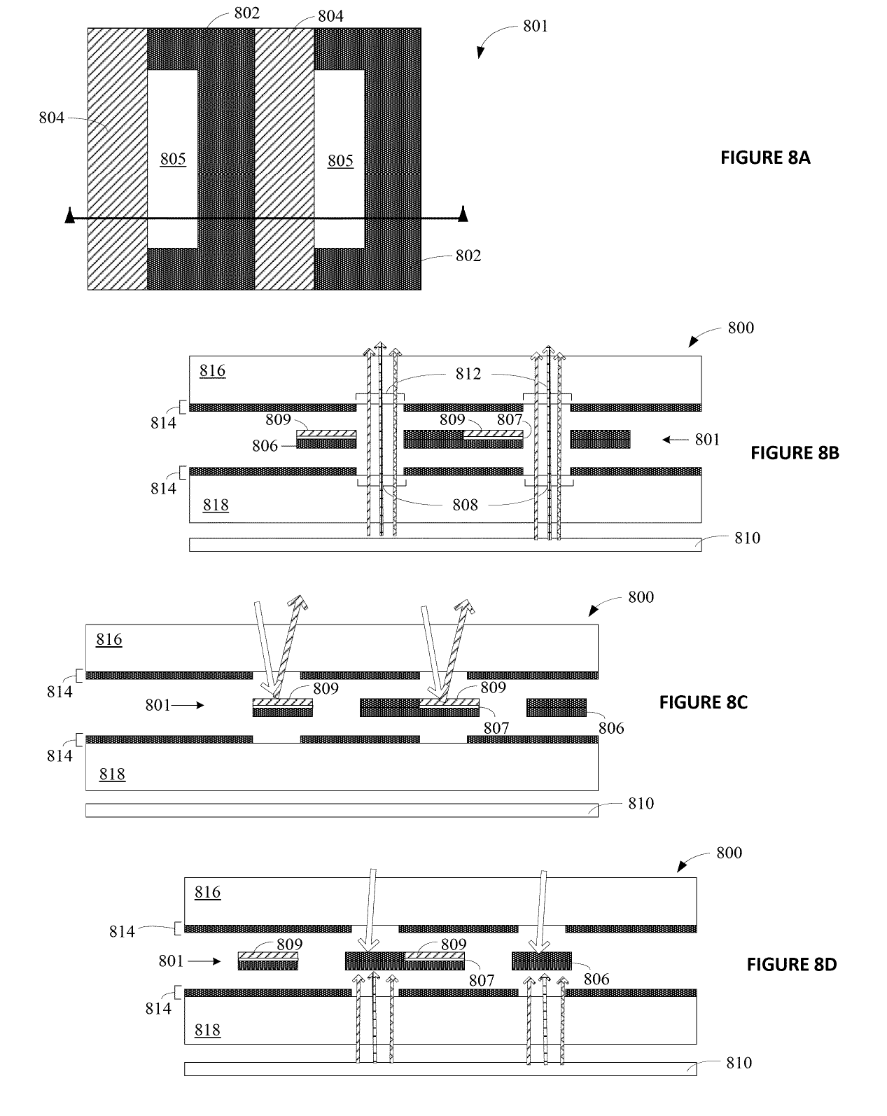

FIGS. 8A-8D show various example views of another dual-mode display apparatus 800 and components thereof. FIG. 8A shows an example plan view of another shutter 801 for use in the display apparatus 800. FIGS. 8B-8D show example cross-sectional views of the display apparatus 800. Like the display apparatus 700 shown in FIGS. 7A-7F, the display apparatus 800 is configured for switching between a transmissive mode of operation and a reflective mode of operation. To support operation in both modes, the display apparatus 800, like the display apparatus 700, can move each shutter included in the display apparatus 800 into three distinct positions along a single axis of motion. In contrast, however, the shutter 801 included in the display apparatus 800 is configured to be able to transition between each of the three states without having to move as far, allowing for faster and lower-power operation.

Referring to FIGS. 8A-8D, the shutter 801 includes two light absorbing portions 802, two light reflecting portions 804, and two apertures 805 formed through the body of the shutter 801 (referred to as “shutter apertures 805”) to permit the passage of light through the shutter 801. The primary structural layer of the shutter 801 is formed from light absorbing material. The light reflecting portions 804 are formed by deposition and patterning of a layer of reflective material 807, such as Al. The light reflecting portions 804 of the shutter are associated with a particular color, such as red, green, blue, cyan, yellow, magenta, or white. To selectively reflect the color associated with the shutter 801, a color selection structure 809 is formed on each of the two light reflecting portions 804. The color selection structures 809 can be a typical resin color filter, a diffraction grating, or any other structure that selectively passes light of a desired color.

As set forth above, the shutter 801 can be driven along a single axis into at least three different states. In each state, the shutter 801 obtains a different position relative to two pairs of opposing apertures. A rear pair of apertures 808 is positioned between a backlight 810 and the shutter 801. A front pair of apertures 812 is positioned between the shutter 801 and the front of the display apparatus 800. In some implementations, the apertures 808 and 812 are patterned into layers of light absorbing material 814 deposited on front and rear substrates 816 and 818, respectively. As with the display apparatus 700 shown in FIGS. 7A-7F, the display apparatus 800 can be built according to either a MEMS-up or a MEMS-down configuration.

The display apparatus 800 operates similarly to the display apparatus 700. In a transmissive mode of operation, the backlight 810 emits light through the rear apertures 808 towards the front apertures 812 and the front of the display apparatus 800. The display apparatus 800 modulates this light by selectively moving the shutter 801 between a transmissive state in which the shutter 801 does not obstruct the path of light through the apertures (shown in FIG. 8B) to a light blocking state (shown in FIG. 8D). In the transmissive state, the shutter apertures 805 align with the rear pair of apertures 808 and the front pair of apertures 812. In the light blocking state, the light blocking portions 802 of the shutter 801 are positioned directly between the front and rear pairs of apertures 812 and 808. In this state, the shutter 801 blocks light emitted by the backlight 810 and absorbs ambient light received from beyond the front of the display apparatus 800. In some implementations, the backlight 810 alternates between emitting light of different colors according to a FSC image formation process.

In a reflective mode, the backlight 810 is turned off. Instead, the display apparatus 800 modulates ambient light. In this mode, the display apparatus 800 selectively moves the shutter 801 between the light blocking state (shown in FIG. 8B) to a light reflecting state (shown in FIG. 8C). In the light reflecting state, the shutter 801 is positioned such that the light reflecting portions 804 of the shutter 801 are positioned directly between the front and rear pairs of apertures 812 and 808.

While the shutter 801 has the light reflecting portions 804 lying directly adjacent to the shutter apertures 805, in some other implementations, the shutter 801 includes a small boundary region of light absorbing material around the shutter apertures 805. The boundary region provides for additional alignment tolerance between the front and rear substrates 816 and 818.

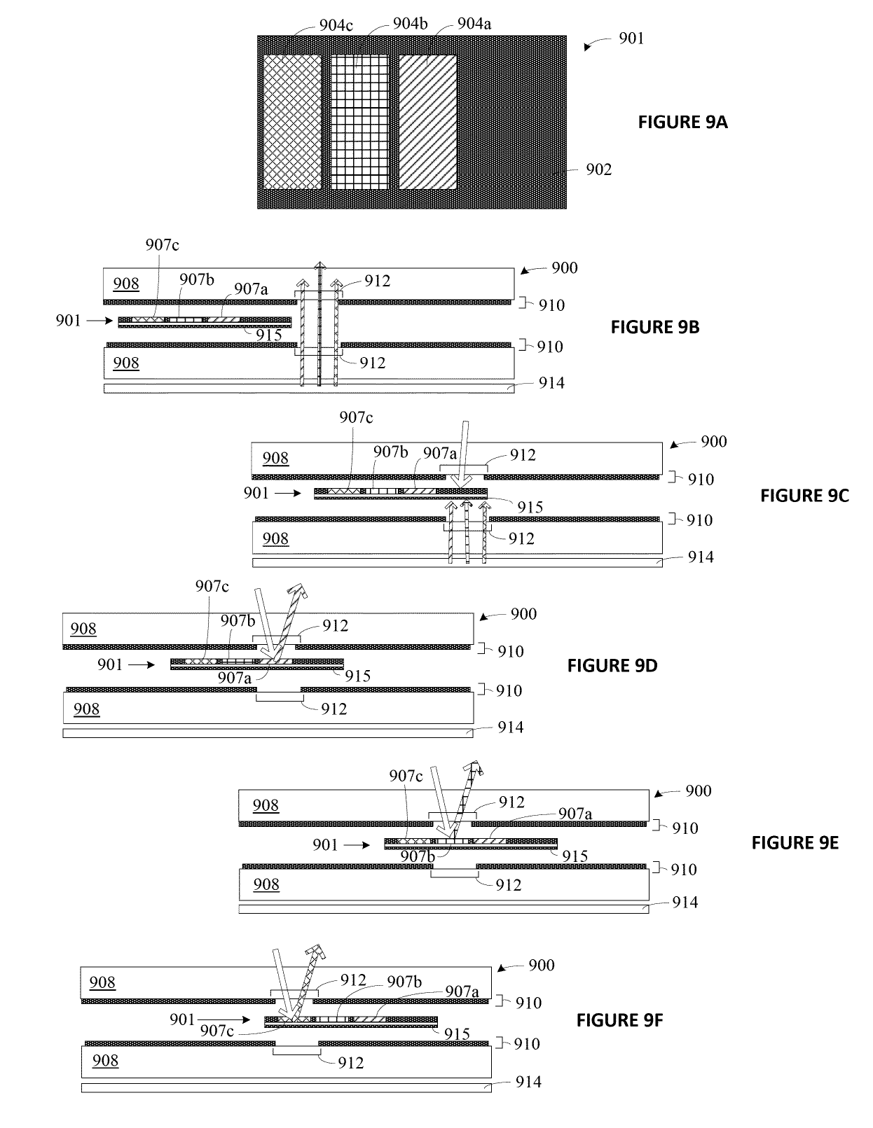

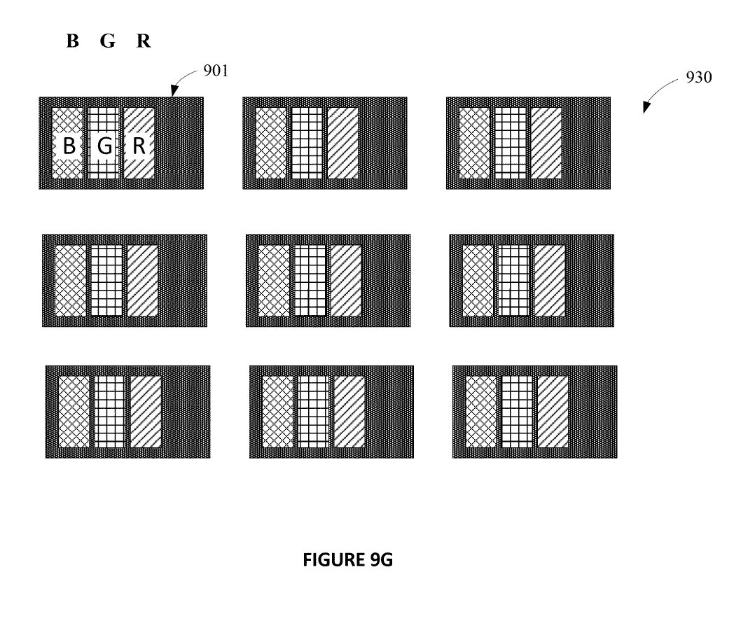

FIGS. 9A-9G show various example views of a dual-mode display apparatus 900 and components thereof. FIG. 9A shows an example plan view of a five-state shutter 901 for use in a dual-mode display apparatus. FIGS. 9B-9F show example cross-sectional views of the display apparatus 900 in each of the five states the shutter 901 is capable of achieving. FIG. 9G shows an example pixel layout for the display apparatus shown in FIGS. 9B-9F.

Referring to FIG. 9A, the shutter 901 is configured to be moved into five different states along a single axis of motion. In contrast to the shutters 701 and 801, depicted in FIGS. 7A and 8A, which only reflect one color when used in a reflective mode, the shutter 901 shown in FIG. 9A can reflect three different colors. Thus, the shutter 901 can be moved into a light transmissive state (shown below in FIG. 9B), a light absorbing state (shown in FIG. 9C), and three reflective states (shown in FIGS. 9D-9F). Each reflective state corresponds to a primary color employed by the display apparatus 900, such as red, green or blue, or cyan, yellow, or magenta. In some implementations, the shutter is configured to enter a fourth state for reflecting white light.

Accordingly, the shutter 901 includes a light absorbing portion 902, and three light reflective portions 904a, 904b and 904c. The light absorbing material 906 that forms the light absorbing portions 902 also extends around the light reflective regions 904a, 904b and 904c to provide increased alignment tolerance between the substrate on which the shutter 901 is fabricated and an opposing substrate. Similar to the display apparatus 700 and 800 shown in FIGS. 7A-7F and 8A-8D, the display apparatus 900 includes two substrates 908, each having a light-blocking layer 910 deposited thereon. Apertures 912 are formed in each of the light blocking layers 910 to form an optical path from a backlight 914 to the front of the display apparatus 900. If the substrates 908 were misaligned and the reflective portions 904a, 904b and 904c were directly adjacent to one another, then in a given reflective state, light might simultaneously reflect off two of the light reflective portions, reducing the color fidelity of the display apparatus 900. By surrounding the light reflecting portions 904a, 904b and 904c with light absorbing material, misalignment only results in a light reflective portion reflecting less light than intended as opposed to reflecting two different colors of light. In alternative implementations, the light reflective portions 904a, 904b and 904c are surrounded by a white reflective material.

The light reflective portions 904a, 904b and 904c, similar to the light reflective portions 704 and 804 shown in FIGS. 7A and 8A, include a layer of reflective material and a color selection structure. To provide reflection of different colors, each of the light reflective portions 904a, 904b and 904c has a different color selection structure 907a, 907b and 907c configured to selectively pass a corresponding color of light. To reduce the possibility of light emitted from the backlight reflecting off the rear-facing surface of the shutter 901 and rebounding out of the display apparatus 900 while in the transmissive mode, thereby reducing its contrast ratio, the rear-facing side of the shutter 900 can include another light absorbing layer 915.

The display apparatus 900, unlike the display apparatus 700 and 800 can utilize FSC imaging formation techniques in both the transmissive and reflective modes. In the transmissive mode of operation, the display apparatus 900 sequentially illuminates a set of primary colors, moving each of the shutters 901 in the display apparatus into either a light transmissive state (shown in FIG. 9B) or a light absorbing state (shown in FIG. 9C), for each color, depending on image data provided to the display apparatus.

In the reflective mode of operation, the display apparatus moves the shutter 901 to either the light absorbing state or to a particular color reflective state according to a FSC sequence. For example, for a first subframe, the display apparatus 900 may move the shutters 901 to either the light absorbing state or a red reflective state (shown in FIG. 9D). For the next subframe, the display apparatus 900 may move the shutters 901 to either the light absorbing state or a green reflective state (shown in FIG. 9E). Then in for a third subframe, the display apparatus 900 may move the shutters 901 to either the light absorbing state or a blue reflective state (shown in FIG. 9F). The above sequence is merely illustrative in nature. In various implementations, the display apparatus can implement a wide variety of FSC subframe sequences.

In some other implementations, the display apparatus 900 can be configured to switch between operating in a FSC reflective mode and a simultaneous color reflective mode. In the latter mode, groups of three shutters 901 are grouped together to form a full color pixel. Each shutter in the group is then assigned to reflect a single color. The resolution of the display apparatus 900 would be decreased in this mode, but the it would be able to generate a greater number of colors, by allocating more time to form each color than used in a FSC operating mode. This extra time allocation allows for more shutter transitions per color. Alternatively, the display apparatus 900 could generate a similar number of colors while operating at lower-power, as the display would be able to reduce the number of addressing phases by two-thirds.

FIG. 9G shows an example pixel layout 930 suitable for use with the display apparatus 900. As each shutter is capable of reflecting each of the primary colors used by the display apparatus 900, the display apparatus need only use one shutter 901 per pixel in both the reflective and transmissive modes of operation.

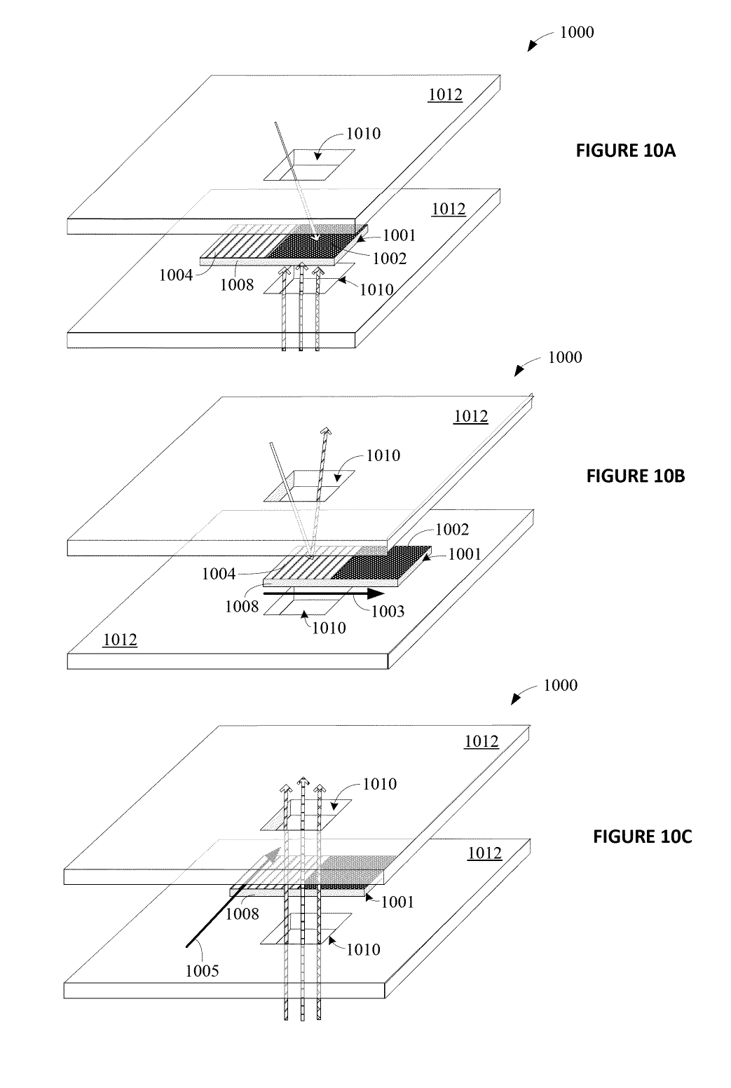

FIGS. 10A-10C show example isometric views of a dual-mode display apparatus 1000. The display apparatus 1000 is similar to the display apparatus 700 shown in FIGS. 7A-7F in that it can operate in both a light transmissive and a light reflecting mode. In contrast, however, the display apparatus 1000 includes a shutter 1001 configured to be moved into three different states through movement along two orthogonal axes. The shutters 701 and 801 moved along only one axis. The shutter 1001 shown in FIGS. 10A-10C moves from a light absorbing state (shown in FIG. 10A) to a light reflective state (shown in FIG. 10B) through movement along a first axis 1003, and from the light absorbing state to a light transmissive state (shown in FIG. 10C) through movement along a second axis 1005, orthogonal to the first axis.

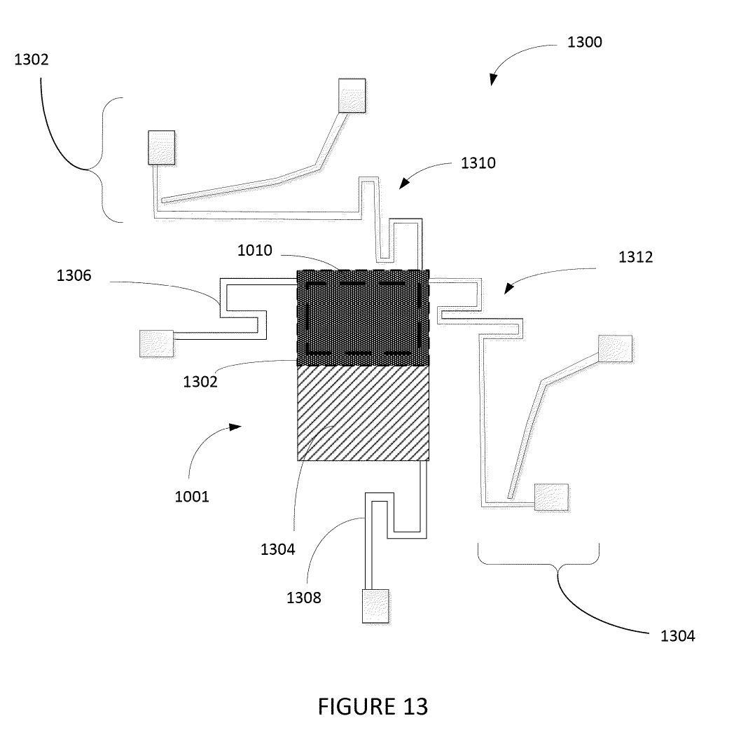

In some implementations, the shutter 1001 is configured to have a rest position to which it returns in an unactuated state. In the implementation shown in FIGS. 10A-10C, the light absorbing state (shown in FIG. 10A) serves as the rest position of the shutter 1001. Accordingly, when operating in a reflective mode, the display apparatus 1000 need only actuate the shutter 1001 along the first axis 1003. In a reflective mode of operation, the display apparatus need only actuate the shutter along the second axis 1005. A suitable shutter actuation mechanism for moving the shutter 1001 is shown in FIG. 13.

Like the shutters 701 and 801 shown in FIGS. 7A and 8A, the shutter 1001 includes a light absorbing portion 1002 and a light reflective portion 1004. The light reflective portion 1004 is configured to reflect light of a particular color. Thus, the light reflective portion 1004 includes a color selection structure, such as a resin color filter, a diffraction grating, or other suitable color selection structure formed above a reflective surface. As shown in FIGS. 10A-10C, the primary structural component of the shutter 1001 is a reflective material 1008, such as Al. The light absorbing portion 1002 of the shutter 1001 is formed by depositing a light absorbing material on top of the reflective material 1008. In some other implementations, the shutter 1001 incorporates a light absorbing layer as its primary structural component.

The display apparatus 1000, in addition to the shutter 1001, includes two substrates (not shown) located in front of and behind the shutter 1001. The shutter is formed as part of a shutter assembly on one of the substrates. The display apparatus 1000 can be formed in either a MEMS-up or a MEMS-down configuration.

The state of the shutter 1001 can be determined based on the relative position of the light absorbing portion 1002 and the light reflecting portion 1004 with respect to apertures 1010 formed in layers of light blocking material 1012 deposited on the substrates. If the light absorbing portion 1002 lies within an optical path between the apertures 1010 (as shown in FIG. 10A), the shutter 1001 is in the light absorbing state. If the light reflecting portion 1004 lies within the optical path between the apertures 1010 (as shown in FIG. 10B), the shutter 1001 is in the light reflecting state. If neither portion 1002 or 1004 lies within the optical path (as shown in FIG. 10C), the shutter 1001 is in the light transmissive state.

In the transmissive mode, the display apparatus 1000 can operate according to a FSC image formation process. In the FSC process, the shutters 1001 in the display apparatus 1000 modulate light of different colors emitted by a backlight in successive image subframes. Thus, each shutter 1001 can serve as its own pixel in the transmissive mode. In the reflective mode, as each shutter 1001 is configured to selectively reflect only one color of light, pixels are formed from groups of at least three shutters. Therefore, the display apparatus 1000 employs a pixel layout similar to the pixel layout 720 or 730 shown in FIGS. 7E and 7F respectively.

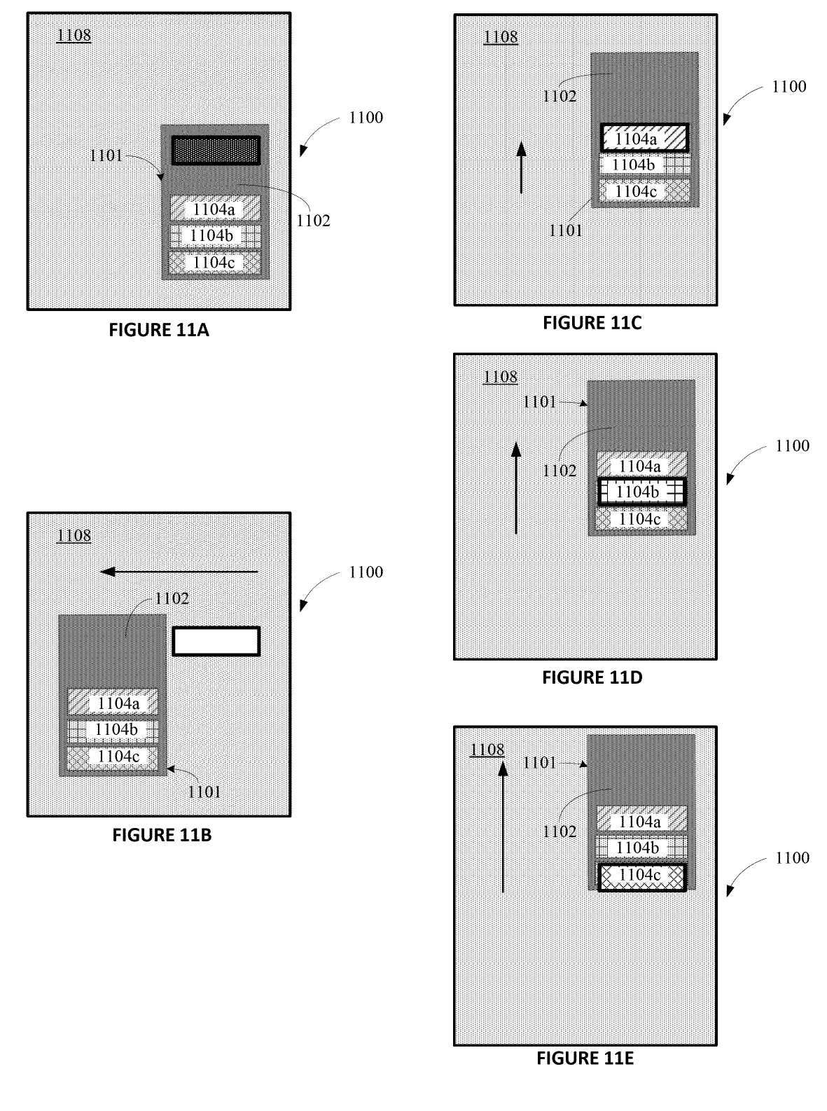

FIGS. 11A-11E show example plan views of another dual-mode display apparatus 1100. Like the display apparatus 900 shown in FIG. 9A-9F, the display apparatus 1100 shown in FIGS. 11A-11E includes a shutter 1101 that can be moved into 5 different states, including a light absorbing state (shown in FIG. 11A), a light transmissive state (shown in FIG. 11B), and three light reflecting states (shown in FIGS. 11C-11E), in which the shutter 1101 reflects three different corresponding colors. For example, the shutter may reflect red, green and blue light, or cyan, yellow and magenta light in the respective light reflecting states. In some other implementations, the shutter 1101 is configured to have a fourth reflecting state in which it reflects white light or some other color of light.

By selectively moving the shutter 1101 between the light absorbing state and the light transmissive state, the display apparatus 1100 can operate in transmissive mode. By selectively moving the shutter 1101 between the light absorbing state and one of the light reflecting states, the display apparatus can operate in an FSC reflective mode.

The shutter 1101, like the shutter 901 shown in FIG. 9A, includes a light absorbing portion 1102 and three light reflective portions 1104a, 1104b and 1104c. Each of the light reflecting portions 1104a, 1104b and 1104c is configured to reflect a different color of light, and therefore includes a different color selection structure.

FIGS. 11A-11E show the shutter 1101 through a light blocking layer 1108 formed on a front facing substrate of the display apparatus 1100. The light blocking layer 1108 is shown to be partially transparent in the figures, so that the relative positions of the shutter 1101 in each of its five states can be discerned. In practice, it would be opaque. The light blocking layer 1108 includes an aperture 1110.

As with the shutter 1001 shown in FIG. 10, the shutter 1101 shown in FIGS. 11A-11E has the light absorbing state (shown in FIG. 11A) as its rest position. Thus, when the actuators that move the shutter 1101 are relaxed, the shutter 1101 returns to the light absorbing state. In this way, to achieve any given state, the shutter need only be moved along a single axis depending on its mode of operation. In the light transmissive mode, the shutter need only move along a first axis 1110 such that either the light absorbing portion 1102 is visible through the aperture 1110 or the shutter 1101 is moved out of the way of light passing through the aperture 1110. In the light reflecting mode, the shutter 1101 need only move along a second axis 1112. As result, in some implementations, the shutter can be moved into its various states using only one actuator at a time.

The distance the shutter 1101 moves along the second axis dictates the color the shutter 1101 will reflect. In a first light reflecting state (shown in FIG. 11C), corresponding to a first displacement of the shutter 1101 along the second axis, the first light reflecting portion 1104a is visible through the aperture 1110. In this state, the shutter 1101 reflects light corresponding to the color of the first light reflecting portion 1104a. In a second light reflecting state (shown in FIG. 11D), corresponding to a second displacement of the shutter 1101 along the second axis, the second light reflecting portion 1104b is visible through the aperture 1110. In this state, the shutter 1101 reflects light corresponding to the color of the second light reflecting portion 1104b. Similarly, in the third light reflecting state (shown in FIG. 11E), corresponding to a third displacement of the shutter 1101 along the second axis, the shutter reflects light corresponding to the third light reflecting portion 1104c.

FIG. 12 shows a plan view of an example shutter assembly 1200 suitable for use in the display apparatus 700 shown in FIGS. 7B-7F. Referring to FIGS. 7A-7F and FIG. 12, the shutter assembly 1200 includes the shutter 701 supported between two actuators 1202 and 1204.

When both actuators 1202 and 1204 are in a non-energized, relaxed state, the shutter 701 can be positioned about an even distance between the two actuators, with the light absorbing portion 702 of the shutter positioned between a pair of corresponding apertures 708 and 712 (shown in FIG. 7B). In response to an actuation voltage being applied across a first of the actuators 1202, the first actuator 1202 moves the light reflecting portion 704 of the shutter 701 into alignment with the apertures 708 and 712, putting the shutter 701 into a reflective state (shown in FIG. 7C). In response to an actuation voltage being applied to the second actuator 1204, the second actuator 1204 moves the shutter 701 out from between the apertures 708 and 712, putting the shutter 701 into the light transmissive state (shown in FIG. 7A).

A similar shutter assembly can be employed to control the shutter 800 shown in FIGS. 8A-8D. However, for such a shutter assembly, the rest state would be transmissive (shown in FIG. 8B), with opposing actuators moving the shutter 801 in one of two opposite directions into the reflective state (shown in FIG. 8B) or the light absorbing state (shown in FIG. 8C).

The shutter assembly 1200 can be modified further for use in the display apparatus 900 shown in FIGS. 9A-9F. The display apparatus 900 moves shutters between five different states along a single axis. For the shutter assembly 1200 to be able to reliably enter additional states, modifications to the actuators 1202 and 1204 are made. The voltage response of the actuators 1202 and 1204 is based, in part, on the curvature of the compliant drive beam electrodes 1206 included therein. Actuators that include straight drive beams or beams having a second-order curvature operate largely in a binary fashion. That is, upon the application of a minimum actuation voltage to such an actuator, the actuator substantially fully actuates, moving a shutter attached thereto a full actuation distance. Actuators including beams which have a third order curvature, however, operate in a largely analog fashion. With such actuators, an incremental increase in the voltage applied across the actuator yields an incremental displacement of the shutter. Thus, the actuators 1202 and 1204 can be modified to include compliant drive beam electrodes having third-order curvatures, allowing the display apparatus 1200 to move a shutter, such as the shutter 901 into multiple different positions along a single axis.

FIG. 13 shows a plan view of an example shutter assembly 1300 suitable for use in the display apparatus 1000 shown in FIGS. 10A-10C. The shutter assembly 1300 includes the shutter 1001 shown in FIG. 10A coupled to two actuators 1302 and 1304 and two return springs 1306 and 1308.

The actuator 1302 can be an electrostatic actuator formed from a pair of compliant beam electrodes, which when actuated, draw together, moving the shutter along the first axis as shown in FIG. 10B. An electrode of the actuator 1302 that couples to the shutter 1001 includes a serpentine portion 1310, which allows the shutter 1301 to move along the second axis shown in FIG. 10C, when the second actuator 1304 is actuated.

The actuator 1304 can be a similarly constructed actuator for moving the shutter 1001 along the second axis. The actuator 1304 is likewise coupled to the shutter 1001 by a beam that forms an electrode of the actuator 1304 and includes a serpentine beam portion 1312 to allow the shutter 1001 to move along the first axis.

The return springs 1306 and 1308 are formed from serpentine beams similar to the serpentine portions 1310 and 1312 of the beams coupling the actuators 1302 and 1304 to the shutter 1001. The return springs 1306 and 1308, however, are less stiff than the serpentine beam portions 1310 and 1312, such that the force applied by the actuators 1302 and 1304 are not overly damped by the return springs 1306 and 1308.

The shutter assembly 1300 can be modified to be suitable for use for moving the shutters 1101 included in the display apparatus 1100 shown in FIGS. 11A-11F. In a manner similar to the modifications made to the shutter assembly 1200 (shown in FIG. 12) to make it suitable for use in the display apparatus 900 (shown in FIGS. 9B-9F), the actuator 1304 can be modified to increase the number of states into which it can move the shutter 1101. More particularly, the actuator 1304 can be modified to include a drive beam electrode having a third-order curvature. Such an actuator can be controlled in an analog fashion. Thus, the display apparatus 1100 can use such an actuator to move the shutter 1301 into multiple positions along the second axis corresponding to its respective reflective states.

While various shutter assembly architectures have been described above in relation to FIGS. 12 and 13, a variety of alternative actuator architectures also may be employed in other implementations.

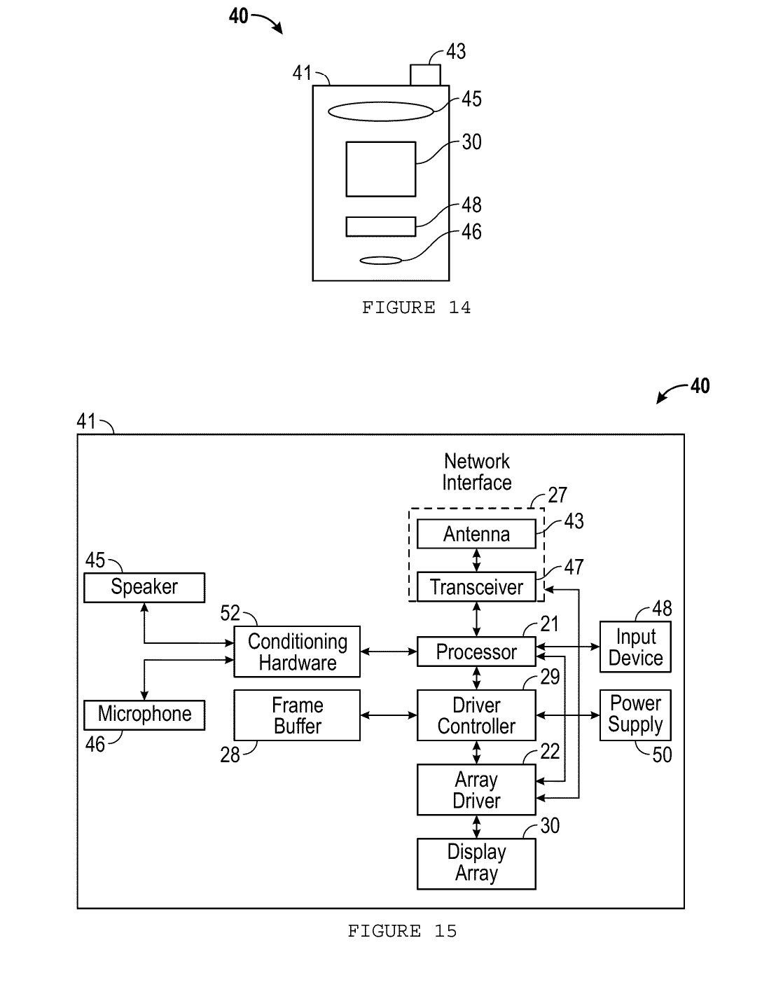

FIGS. 14 and 15 show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 14. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 14, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus, comprising:
an array of electromechanical systems (EMS) light modulators, each light modulator configured to achieve at least three states, including:
a non-transmissive, non-reflective state,
a light transmissive state in which the light modulator transmits light, and
a first reflective state, in which the light modulator reflects a color.

2. The apparatus of claim 1, comprising a controller configured to operate the array of light modulators:
in a transmissive mode in which the controller is configured to cause the light modulators in the array to be selectively driven between the non-transmissive, non-reflective state and the light transmissive state, and
in a reflective mode in which the controller is configured to cause the light modulators in the array to be selectively driven between the non-transmissive, non-reflective state and the first reflective state.

3. The apparatus of claim 2, wherein the controller includes mode selection logic configured to switch between the transmissive mode and the reflective mode in response to at least one of user input, ambient light data, power source data, and host processor instruction.

4. The apparatus of claim 2, comprising a backlight, and wherein in the transmissive mode, the light modulators transmit light emitted by the backlight in the light transmissive state, and block light emitted by the backlight in the non-transmissive, non-reflective state.

5. The apparatus of claim 1, wherein the array includes three light modulators to form each pixel of an image in a reflective mode of operation and wherein each of the three light modulators associated with a given pixel reflects a different color.

6. The apparatus of claim 1, wherein the light modulators are configured to achieve at least a fourth state including a second reflective state in which the light modulator reflects a second color.

7. The apparatus of claim 1, wherein the light modulator is configured to transition between the non-transmissive, non-reflective state and the light transmissive state through movement in a first direction having a first axis of motion and to transition between the non-transmissive, non-reflective state and the first reflective state through movement in a second direction having a second, different axis of motion.

8. The apparatus of claim 7, wherein the first axis of motion is substantially perpendicular to the second axis of motion.

9. The apparatus of claim 1, wherein the light modulator is configured to transition between the non-transmissive, non-reflective state and the light transmissive state through movement of a first distance in a first direction and to transition between the non-transmissive, non-reflective state and the first reflective state through movement of a second, greater distance in the first direction.

10. The apparatus of claim 1, wherein each light modulator includes a light obstructing component having a light absorbing surface and at least one reflective surface.

11. The apparatus of claim 10, wherein the light absorbing surface includes a layer of light absorbing material deposited on top of a portion of the at least one reflective surface.

12. The apparatus of claim 10, wherein the at least one reflective surface of each light modulator includes a corresponding color filter to reflect light of a corresponding color.

13. The apparatus of claim 12, wherein the at least one reflective surface includes three reflective surfaces.

14. The apparatus of claim 13, wherein the at least three reflective surfaces include a first reflective surface having a red color filter formed thereon, a second reflective surface having a green color filter formed thereon, and a third reflective surface having a blue color filter formed thereon.

15. The apparatus of claim 13, further comprising light absorbing material surrounding at least one of the at least three reflective surfaces.

16. The apparatus of claim 12, wherein the light modulator is configured, when operating a reflective mode, to selectively transition between the non-transmissive, non-reflective state and one of three color reflective states according to a field sequential color image formation process.

17. The apparatus of claim 1, further comprising:
a display including the array of EMS light modulators;
a processor that is configured to communicate with the display, the processor being configured to process image data; and
a memory device that is configured to communicate with the processor.

18. The apparatus of claim 17, further comprising:
a driver circuit configured to send at least one signal to the display; and wherein
the processor is further configured to send at least a portion of the image data to the driver circuit.

19. The apparatus of claim 17, further comprising:
an image source module configured to send the image data to the processor, wherein the image source module comprises at least one of a receiver, transceiver, and transmitter.

20. The apparatus of claim 17, further comprising:
an input device configured to receive input data and to communicate the input data to the processor.

21. An apparatus, comprising:
an array of light modulating means, wherein each light modulating means can be transitioned between three separate states, including:
a non-transmissive, non-reflective state,
a light transmissive state in which the light modulating means transmits light, and
a first reflective state, in which the light modulating means reflects a color.

22. The apparatus of claim 21, comprising a means for controlling the array of light modulating means:
in a transmissive mode in which the controlling means is configured to cause the light modulating means in the array to be selectively driven between the non-transmissive, non-reflective state and the light transmissive state, and
in a reflective mode in which the controlling means is configured to cause the light modulating means in the array to be selectively driven between the non-transmissive, non-reflective state and the first reflective state.

23. The apparatus of claim 21, comprising a light emitting means, and wherein in the transmissive mode, the light modulating means transmit light emitted by the light emitting means in the light transmissive state, and block light emitted by the light emitting means in the non-transmissive state.

24. The apparatus of claim 21, wherein the array includes three light modulating means to form each pixel of an image in a reflective mode of operation and wherein each of the three light modulating means associated with a given pixel reflects a different color.

25. The apparatus of claim 21, wherein the light modulating means are configured to achieve at least a fourth state including a second reflective state in which the light modulating means reflects a second color.

26. The apparatus of claim 21, wherein the light modulating means is configured to transition between the non-transmissive, non-reflective state and the light transmissive state through movement in a first direction having a first axis of motion and to transition between the non-transmissive, non-reflective state and the first reflective state through movement in a second direction having a second, different axis of motion.

27. The apparatus of claim 26, wherein the first axis of motion is substantially perpendicular to the second axis of motion.

28. The apparatus of claim 21, wherein the light modulating means is configured to transition between the non-transmissive, non-reflective state and the light transmissive state through movement of a first distance in a first direction and to transition between the non-transmissive, non-reflective state and the first reflective state through movement of a second, greater distance in the first direction.

29. The apparatus of claim 21, wherein each light modulating means includes a means for absorbing light and means for reflecting light.

30. The apparatus of claim 29, wherein the reflecting means includes a color selection means for limiting the color of light reflected by the reflecting means.

31. The apparatus of claim 29, wherein the reflecting means includes color selection means for separately reflecting three different colors.
